(19) United States
(12) Patent Application Publication
(10) Pub. No.: US 2024/0022757 A1
(43) Pub. Date: Jan. 18, 2024

(54) DECODER-SIDE MOTION VECTOR REFINEMENT FOR AFFINE MOTION COMPENSATION

(71) Applicant: Alibaba (China) Co., Ltd., Hangzhou (CN)

(72) Inventors: Jie Chen, Beijing (CN); Ru-Ling Liao, Beijing (CN); Xinwei Li, Beijing (CN); Yan Ye, San Diego, CA (US)

(21) Appl. No.: 18/346,766

(22) Filed: Jul. 3, 2023

Related U.S. Application Data
(60) Provisional application No. 63/358,257, filed on Jul. 5, 2022.
(60) Provisional application No. 63/406,122, filed on Sep. 13, 2022.
(60) Provisional application No. 63/433,478, filed on Jan. 1, 0001.

(51) Int. Cl. H04N 19/513; H04N 19/132; H04N 19/159; H04N 19/176

(52) U.S. Cl. CPC H04N 19/513; H04N 19/132; H04N 19/159; H04N 19/176

(57) ABSTRACT

A VVC-standard encoder and a VVC-standard decoder are provided, implementing application of DMVR on affine merge mode-coded blocks to refine the motion vector accuracy and thereby improve coding efficiency. A refined motion vector (MV) search is performed for a control point motion vector (CPMV) of an inter-coded coding block (CB), outputting a refined MV of the CB. A refined MV search includes deriving a MV of a subblock of the CB based on a CPMV of the CB, performing subblock MV refinement for the MV of the subblock, and outputting the refined MV of the CB based on a refined MV of the subblock. A refined MV search further includes deriving an affine model parameter based on a plurality of CPMVs of the CB, performing an affine parameter offset search for the affine model parameter, and outputting the refined MV of the CB based on an optimal parameter offset.

### RELATED APPLICATIONS

This application claims the benefit of U.S. Patent Application No. 63/358,257, entitled “DECODER-SIDE MOTION VECTOR REFINEMENT FOR AFFINE MOTION COMPENSATION” and filed Jul. 5, 2022, and claims the benefit of U.S. Patent Application No. 63/406,122, entitled “DECODER-SIDE MOTION VECTOR REFINEMENT FOR AFFINE MOTION COMPENSATION” and filed Sep. 13, 2022, and claims the benefit of U.S. Patent Application No. 63/433,748, entitled “DECODER-SIDE MOTION VECTOR REFINEMENT FOR AFFINE MOTION COMPENSATION” and filed Dec. 19, 2022, each of which is expressly incorporated herein by reference in its entirety.

### BACKGROUND

In 2020, the Joint Video Experts Team (“JVET”) of the ITU-T Video Coding Expert Group (“ITU-T VCEG”) and the ISO/IEC Moving Picture Expert Group (“ISO/IEC MPEG”) published the final draft of the next-generation video codec specification, Versatile Video Coding (“VVC”). This specification further improves video coding performance over prior standards such as H.264/AVC (Advanced Video Coding) and H.265/HEVC (High Efficiency Video Coding). The JVET continues to propose additional techniques beyond the scope of the VVC standard itself, collected under the Enhanced Compression Model (“ECM”) name, presented in January 2021, and used as new software base for developing tools beyond the VVC standard.

Inter-picture prediction is critical for video encoding and is conveyed through motion vectors (MVs). Techniques for signaling the MVs reduce the bitrate for transmission to a decoder but generate inaccurate MVs, leading to imprecise prediction. To improve the results of these techniques, decoder-side refinement and/or compensation techniques may be used. Decoder-side Motion Vector Refinement (DMVR), including multi-pass DMVR and adaptive DMVR, is a coding tool to refine the MV in the decoder side without additional signaling, as the MV inheriting from the neighboring block may not perfectly match with the current block. And the affine motion compensation may be used to capture the affine motion between two different frames.

However, in the current design, these two coding tools are used exclusively of each other. That is, DMVR is only applied on non-affine coded blocks to refine the MVs of translation motions. And if blocks are coded with affine mode, DMVR is not used to refine the MVs.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIGS. 1A and 1B illustrate example block diagrams of, respectively, a video encoding process and a video decoding process according to example embodiments of the present disclosure.

FIG. 2 illustrates motion prediction performed upon a current picture according to bi-prediction, wherein offset blocks of reference pictures are used to calculate a refined motion vector that is in turn used to generate a bi-predicted signal.

FIGS. 3A, 3B, and 3C illustrate example diagrams of search patterns used in a first pass of a multi-pass decoder-side motion vector refinement.

FIG. 4 illustrates a diagram of bilateral matching costs used in a second pass of a multi-pass decoder-side motion vector refinement.

FIGS. 5A and 5B illustrate diagrams of the affine motion field of a block with, respectively, four parameters (two control points) and six parameters (three control points). While in the real world there are many kinds of motion (e.g., zoom), according to the VVC standard, a block-based affine transform motion compensation prediction is applied.

FIG. 6 illustrates a diagram of affine motion vectors of luma subblocks calculated for each subblock center sample.

FIG. 7 illustrates a diagram of control point motion vector inheritance, candidates from which are used to form an affine merge candidate list.

FIGS. 8A and 8B illustrate diagrams of, respectively, inherited candidates from non-adjacent neighbors for the affine merge candidate list and constructed candidates of a first type for the affine merge candidate list.

FIG. 9 illustrates a diagram of locations of constructed affine candidates from adjacent neighbors for the affine merge candidate list.

FIG. 10 illustrates a diagram of locations of constructed affine candidates from non-adjacent neighbors for the affine merge candidate list.

FIG. 11 illustrates a diagram of adjacent 4×4 subblock information of which the motion information is fetched for current coding block affine model regression.

FIG. 12 illustrates a diagram of a difference between a subblock motion vector at a location and a motion vector calculated at that location, the difference used as part of a predication refinement with optical flow for a subblock-based affine motion compensated prediction.

FIG. 13 illustrates a diagram of a search window for each sub-block.

FIG. 14 illustrates a diagram of the samples on integer and fractional search point.

FIG. 15 illustrates examples of searching for the affine model parameters with respective MVs at top-left, top-right and bottom-right of a coding block being fixed.

FIG. 16 illustrates an example system for implementing the processes and methods described herein for implementing a decoder-side motion vector refinement for affine motion compensation.

### DETAILED DESCRIPTION

In accordance with the VVC video coding standard (the “VVC standard”) and motion prediction as described therein, computer-readable instructions stored on a computer-readable storage medium are executable by one or more processors of a computing system to configure the one or more processors to perform operations of an encoder as described by the VVC standard, and operations of a decoder as described by the VVC standard. Some of these encoder operations and decoder operations according to the VVC standard are subsequently described in further detail, though these subsequent descriptions should not be understood as exhaustive of encoder operations and decoder operations according to the VVC standard. Subsequently, a “VVC-standard encoder” and a “VVC-standard decoder” shall describe the respective computer-readable instructions stored on a computer-readable storage medium which configure one or more processors to perform these respective operations (which can be called, by way of example, “reference implementations” of an encoder or a decoder).

Moreover, according to example embodiments of the present disclosure, a VVC-standard encoder and a VVC-standard decoder further include computer-readable instructions stored on a computer-readable storage medium which are executable by one or more processors of a computing system to configure the one or more processors to perform operations not specified by the VVC standard. A VVC-standard encoder should not be understood as limited to operations of a reference implementation of an encoder, but including further computer-readable instructions configuring one or more processors of a computing system to perform further operations as described herein. A VVC-standard decoder should not be understood as limited to operations of a reference implementation of a decoder, but including further computer-readable instructions configuring one or more processors of a computing system to perform further operations as described herein.

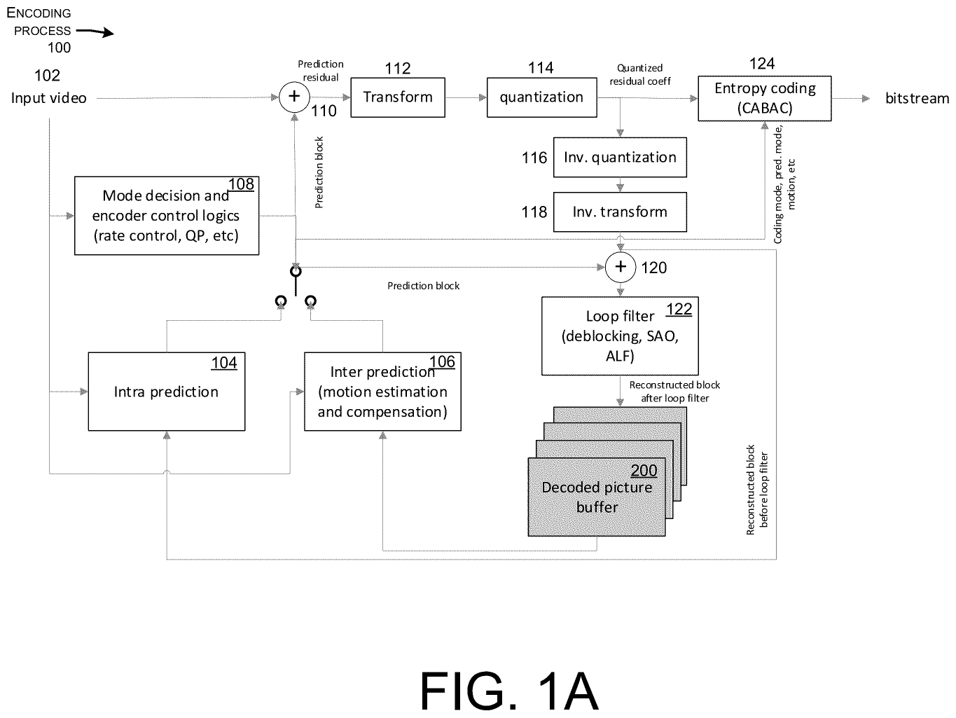

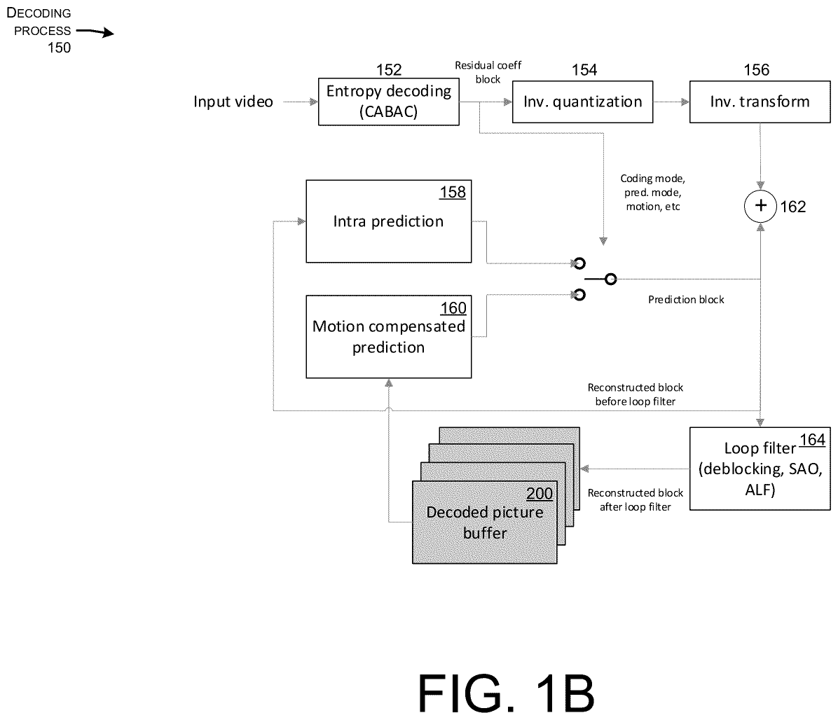

FIGS. 1A and 1B illustrate example block diagrams of, respectively, an encoding process 100 and a decoding process 150 according to an example embodiment of the present disclosure.

In an encoding process 100, a VVC-standard encoder configures one or more processors of a computing system to receive, as input, one or more input pictures from an image source 102. An input picture includes some number of pixels sampled by an image capture device, such as a photosensor array, and includes an uncompressed stream of multiple color channels (such as RGB color channels) storing color data at an original resolution of the picture, where each channel stores color data of each pixel of a picture using some number of bits. A VVC-standard encoder configures one or more processors of a computing system to store this uncompressed color data in a compressed format, wherein color data is stored at a lower resolution than the original resolution of the picture, encoded as a luma (“Y”) channel and two chroma (“U” and “V”) channels of lower resolution than the luma channel.

A VVC-standard encoder encodes a picture (a picture being encoded being called a “current picture,” as distinguished from any other picture received from an image source 102) by configuring one or more processors of a computing system to partition the original picture into units and subunits according to a partitioning structure. A VVC-standard encoder configures one or more processors of a computing system to subdivide a picture into macroblocks (“MBs”) each having dimensions of 16×16 pixels, which may be further subdivided into partitions. A VVC-standard encoder configures one or more processors of a computing system to subdivide a picture into coding tree units (“CTUs”), the luma and chroma components of which may be further subdivided into coding tree blocks (“CTBs”) which are further subdivided into coding blocks (“CBs”). Alternatively, a VVC-standard encoder configures one or more processors of a computing system subdivide a picture into units of N×N pixels, which may then be further subdivided into subunits. Each of these largest subdivided units of a picture may generally be referred to as a “block” for the purpose of this disclosure.

A CB is coded using one block of luma samples and two corresponding blocks of chroma samples, where pictures are not monochrome and are coded using one coding tree.

A VVC-standard encoder configures one or more processors of a computing system to subdivide a block into partitions having dimensions in multiples of 4×4 pixels. For example, a partition of a block may have dimensions of 8×4 pixels, 4×8 pixels, 8×8 pixels, 16×8 pixels, or 8×16 pixels.

By encoding color information of blocks of a picture and subdivisions thereof, rather than color information of pixels of a full-resolution original picture, a VVC-standard encoder configures one or more processors of a computing system to encode color information of a picture at a lower resolution than the input picture, storing the color information in fewer bits than the input picture.

Furthermore, a VVC-standard encoder encodes a picture by configuring one or more processors of a computing system to perform motion prediction upon blocks of a current picture. Motion prediction coding refers to storing image data of a block of a current picture (where the block of the original picture, before coding, is referred to as an “input block”) using motion information and prediction units (“PUs”), rather than pixel data, according to intra prediction 104 or inter prediction 106.

Motion information refers to data describing motion of a block structure of a picture or a unit or subunit thereof, such as motion vectors and references to blocks of a current picture or of a reference picture. PUs may refer to a unit or multiple subunits corresponding to a block structure among multiple block structures of a picture, such as an MB or a CTU, wherein blocks are partitioned based on the picture data and are coded according to the VVC standard. Motion information corresponding to a PU may describe motion prediction as encoded by a VVC-standard encoder as described herein.

A VVC-standard encoder configures one or more processors of a computing system to code motion prediction information over each block of a picture in a coding order among blocks, such as a raster scanning order wherein a first-decoded block is an uppermost and leftmost block of the picture. A block being encoded is called a “current block,” as distinguished from any other block of a same picture.

According to intra prediction 104, one or more processors of a computing system are configured to encode a block by references to motion information and PUs of one or more other blocks of the same picture. According to intra prediction coding, one or more processors of a computing system perform an intra prediction 104 (also called spatial prediction) computation by coding motion information of the current block based on spatially neighboring samples from spatially neighboring blocks of the current block.

According to inter prediction 106, one or more processors of a computing system are configured to encode a block by references to motion information and PUs of one or more other pictures. One or more processors of a computing system are configured to store one or more previously coded and decoded pictures in a reference picture buffer for the purpose of inter prediction coding; these stored pictures are called reference pictures.

One or more processors are configured to perform an inter prediction 106 (also called temporal prediction or motion compensated prediction) computation by coding motion information of the current block based on samples from one or more reference pictures. Inter prediction may further be computed according to uni-prediction or bi-prediction: in uni-prediction, only one motion vector, pointing to one reference picture, is used to generate a prediction signal for the current block. In bi-prediction, two motion vectors, each pointing to a respective reference picture, are used to generate a prediction signal of the current block.

A VVC-standard encoder configures one or more processors of a computing system to code a CB to include reference indices to identify, for reference of a VVC-standard decoder, the prediction signal(s) of the current block. One or more processors of a computing system can code a CB to include an inter prediction indicator. An inter prediction indicator indicates list 0 prediction in reference to a first reference picture list referred to as list 0, list 1 prediction in reference to a second reference picture list referred to as list 1, or bi-prediction in reference to both reference picture lists referred to as, respectively, list 0 and list 1.

In the cases of the inter prediction indicator indicating list 0 prediction or list 1 prediction, one or more processors of a computing system are configured to code a CB including a reference index referring to a reference picture of the reference picture buffer referenced by list 0 or by list 1, respectively. In the case of the inter prediction indicator indicating bi-prediction, one or more processors of a computing system are configured to code a CB including a first reference index referring to a first reference picture of the reference picture buffer referenced by list 0, and a second reference index referring to a second reference picture of the reference picture referenced by list 1.

A VVC-standard encoder configures one or more processors of a computing system to code each current block of a picture individually, outputting a prediction block for each. According to the VVC standard, a CTU can be as large as 128×128 luma samples (plus the corresponding chroma samples, depending on the chroma format). A CTU may be further partitioned into CBs according to a quad-tree, binary tree, or ternary tree. One or more processors of a computing system are configured to ultimately record coding parameter sets such as coding mode (intra mode or inter mode), motion information (reference index, motion vectors, etc.) for inter-coded blocks, and quantized residual coefficients, at syntax structures of leaf nodes of the partitioning structure.

After a prediction block is output, a VVC-standard encoder configures one or more processors of a computing system to send coding parameter sets such as coding mode (i.e., intra or inter prediction), a mode of intra prediction or a mode of inter prediction, and motion information to an entropy coder 124 (as described subsequently).

The VVC standard provides semantics for recording coding parameter sets for a CB. For example, with regard to the above-mentioned coding parameter sets, pred_mode_flag for a CB is set to 0 for an inter-coded block, and is set to 1 for an intra-coded block; general_merge_flag for a CB is set to indicate whether merge mode is used in inter prediction of the CB; inter_affine_flag and cu_affine_type_flag for a CB are set to indicate whether affine motion compensation is used in inter prediction of the CB; mvp_l0_flag and mvp_l1_flag are set to indicate a motion vector index in list 0 or in list 1, respectively; and ref_idx_l0 and ref_idx_l1 are set to indicate a reference picture index in list 0 or in list 1, respectively. It should be understood that the VVC standard includes semantics for recording various other information, flags, and options which are beyond the scope of the present disclosure.

A VVC-standard encoder further implements one or more mode decision and encoder control settings 108, including rate control settings. One or more processors of a computing system are configured to perform mode decision by, after intra or inter prediction, selecting an optimized prediction mode for the current block, based on the rate-distortion optimization method.

A rate control setting configures one or more processors of a computing system to assign different quantization parameters (“QPs”) to different pictures. Magnitude of a QP determines a scale over which picture information is quantized during encoding by one or more processors (as shall be subsequently described), and thus determines an extent to which the encoding process 100 discards picture information (due to information falling between steps of the scale) from MBs of the sequence during coding.

A VVC-standard encoder further implements a subtractor 110. One or more processors of a computing system are configured to perform a subtraction operation by computing a difference between an input block and a prediction block. Based on the optimized prediction mode, the prediction block is subtracted from the input block. The difference between the input block and the prediction block is called prediction residual, or “residual” for brevity.

Based on a prediction residual, a VVC-standard encoder further implements a transform 112. One or more processors of a computing system are configured to perform a transform operation on the residual by a matrix arithmetic operation to derive an array of coefficients (which can be referred to as “residual coefficients,” “transform coefficients,” and the like), thereby encoding a current block as a transform block (“TB”). Transform coefficients may refer to coefficients representing one of several spatial transformations, such as a diagonal flip, a vertical flip, or a rotation, which may be applied to a sub-block.

It should be understood that a coefficient can be stored as two components, an absolute value and a sign, as shall be described in further detail subsequently.

Sub-blocks of CBs, such as PUs and TBs, can be arranged in any combination of sub-block dimensions as described above. A VVC-standard encoder configures one or more processors of a computing system to subdivide a CB into a residual quadtree (“RQT”), a hierarchical structure of TBs. The RQT provides an order for motion prediction and residual coding over sub-blocks of each level and recursively down each level of the RQT.

A VVC-standard encoder further implements a quantization 114. One or more processors of a computing system are configured to perform a quantization operation on the residual coefficients by a matrix arithmetic operation, based on a quantization matrix and the QP as assigned above. Residual coefficients falling within an interval are kept, and residual coefficients falling outside the interval step are discarded.

A VVC-standard encoder further implements an inverse quantization 116 and an inverse transform 118. One or more processors of a computing system are configured to perform an inverse quantization operation and an inverse transform operation on the quantized residual coefficients, by matrix arithmetic operations which are the inverse of the quantization operation and transform operation as described above. The inverse quantization operation and the inverse transform operation yield a reconstructed residual.

A VVC-standard encoder further implements an adder 120. One or more processors of a computing system are configured perform an addition operation by adding a prediction block and a reconstructed residual, outputting a reconstructed block.

A VVC-standard encoder further implements a loop filter 122. One or more processors of a computing system are configured to apply a loop filter, such as a deblocking filter, a sample adaptive offset (“SAO”) filter, and adaptive loop filter (“ALF”) to a reconstructed block, outputting a filtered reconstructed block.

A VVC-standard encoder further configures one or more processors of a computing system to output a filtered reconstructed block to a decoded picture buffer (“DPB”) 200. A DPB 200 stores reconstructed pictures which are used by one or more processors of a computing system as reference pictures in coding pictures other than the current picture, as described above with reference to inter prediction.

A VVC-standard encoder further implements an entropy coder 124. One or more processors of a computing system are configured to perform entropy coding, wherein, according to the Context-Sensitive Binary Arithmetic Codec (“CABAC”), symbols making up quantized residual coefficients are coded by mappings to binary strings (subsequently “bins”), which can be transmitted in an output bitstream at a compressed bitrate. The symbols of the quantized residual coefficients which are coded include absolute values of the residual coefficients (these absolute values being subsequently referred to as “residual coefficient levels”).

The entropy coder configures one or more processors of a computing system to code residual coefficient levels of a block; bypass coding of residual coefficient signs and record the residual coefficient signs with the coded block; record coding parameter sets such as coding mode, a mode of intra prediction or a mode of inter prediction, and motion information coded in syntax structures of a coded block (such as a picture parameter set (“PPS”) found in a picture header, as well as a sequence parameter set (“SPS”) found in a sequence of multiple pictures); and output the coded block.

A VVC-standard encoder configures one or more processors of a computing system to output a coded picture, made up of coded blocks from the entropy coder 124. The coded picture is output to a transmission buffer, where it is ultimately packed into a bitstream for output from the VVC-standard encoder.

In a decoding process 150, a VVC-standard decoder configures one or more processors of a computing system to receive, as input, one or more coded pictures from a bitstream.

A VVC-standard decoder implements an entropy decoder 152. One or more processors of a computing system are configured to perform entropy decoding, wherein, according to CABAC, bins are decoded by reversing the mappings of symbols to bins, thereby recovering the entropy-coded quantized residual coefficients. The entropy decoder 152 outputs the quantized residual coefficients, outputs the coding-bypassed residual coefficient signs, and also outputs the syntax structures such as a PPS and a SPS.

A VVC-standard decoder further implements an inverse quantization 154 and an inverse transform 156. One or more processors of a computing system are configured to perform an inverse quantization operation and an inverse transform operation on the decoded quantized residual coefficients, by matrix arithmetic operations which are the inverse of the quantization operation and transform operation as described above. The inverse quantization operation and the inverse transform operation yield a reconstructed residual.

Furthermore, based on coding parameter sets recorded in syntax structures such as PPS and a SPS by the entropy coder 124 (or, alternatively, received by out-of-band transmission or coded into the decoder), and a coding mode included in the coding parameter sets, the VVC-standard decoder determines whether to apply intra prediction 156 (i.e., spatial prediction) or to apply motion compensated prediction 158 (i.e., temporal prediction) to the reconstructed residual.

In the event that the coding parameter sets specify intra prediction, the VVC-standard decoder configures one or more processors of a computing system to perform intra prediction 158 using prediction information specified in the coding parameter sets. The intra prediction 158 thereby generates a prediction signal.

In the event that the coding parameter sets specify inter prediction, the VVC-standard decoder configures one or more processors of a computing system to perform motion compensated prediction 160 using a reference picture from a DPB 200. The motion compensated prediction 160 thereby generates a prediction signal.

A VVC-standard decoder further implements an adder 162. The adder 162 configures one or more processors of a computing system to perform an addition operation on the reconstructed residuals and the prediction signal, thereby outputting a reconstructed block.

A VVC-standard decoder further implements a loop filter 164. One or more processors of a computing system are configured to apply a loop filter, such as a deblocking filter, a SAO filter, and ALF to a reconstructed block, outputting a filtered reconstructed block.

A VVC-standard decoder further configures one or more processors of a computing system to output a filtered reconstructed block to the DPB 200. As described above, a DPB 200 stores reconstructed pictures which are used by one or more processors of a computing system as reference pictures in coding pictures other than the current picture, as described above with reference to motion compensated prediction.

A VVC-standard decoder further configures one or more processors of a computing system to output reconstructed pictures from the DPB to a user-viewable display of a computing system, such as a television display, a personal computing monitor, a smartphone display, or a tablet display.

Therefore, as illustrated by an encoding process 100 and a decoding process 150 as described above, a VVC-standard encoder and a VVC-standard decoder each implements motion prediction coding in accordance with the VVC specification. A VVC-standard encoder and a VVC-standard decoder each configures one or more processors of a computing system to generate a reconstructed picture based on a previous reconstructed picture of a DPB according to motion compensated prediction as described by the VVC standard, wherein the previous reconstructed picture serves as a reference picture in motion compensated prediction as described herein.

The VVC standard adopts a bilateral-matching (“BM”)-based decoder-side motion vector refinement (“DMVR”) in bi-prediction to increase the accuracy of the MVs of the merge mode. In DMVR, refined MVs are searched near the initial MVs, MV₀ and MV₁, in the reference picture list 0 (“L0”) and reference picture list 1 (“L1”), where the refined MVs are denoted MV₀′ and MV₁′, respectively. The BM method calculates the distortion between the respective two candidate blocks in the reference pictures L0 and L1.

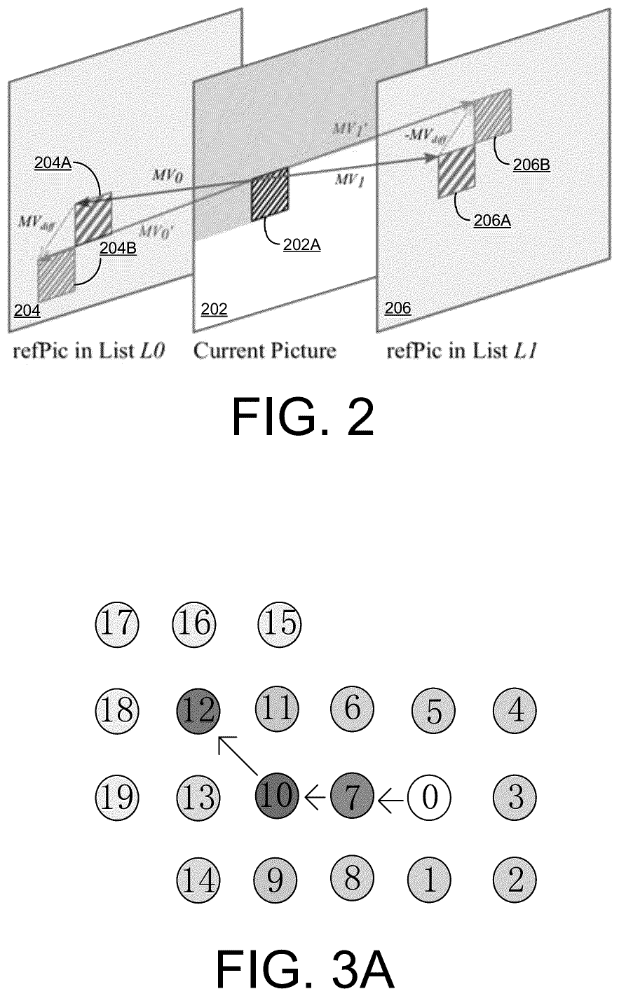

FIG. 2 illustrates motion prediction performed upon a current picture 202 according to bi-prediction, wherein offset blocks of reference pictures are used to calculate a refined motion vector that is in turn used to generate a bi-predicted signal. The current picture 202 includes a current block 202A. Two co-located reference pictures 204 and 206, one from reference list 0 in a first temporal direction, and one from reference list 1 in a second temporal direction, are illustrated in accordance with bi-prediction. Motion information of the current block 202A refers to a co-located reference block 204A of the co-located reference picture 204, and refers to a co-located reference block 206A of the co-located reference picture 206. The co-located reference picture 204 further includes an offset block 204B near the co-located reference block 204A, and the co-located reference picture 206 further includes an offset block 206B near the co-located reference block 206A.

As illustrated in FIG. 2, a sum of absolute differences (“SAD”) between the reference block 204A and the offset block 204B, and a SAD between the reference block 206A and the offset block 206B, are calculated. The MV candidate with the lowest SAD is set as the refined MV and used to generate a bi-predicted signal.

Furthermore, according to the VVC standard, the application of DMVR is restricted and is only applied for the CBs which are coded with following modes and features: CB-level merge mode with bi-prediction MVs, the bi-prediction MVs pointing to respective reference pictures in different temporal directions (i.e., one reference picture is in the past and another reference picture is in the future) with respect to the current picture; the distances (i.e., the picture order count (“POC”) difference) from two reference pictures to the current picture are same; both reference pictures are short-term reference pictures; the current CB has more than 64 luma samples; both CB height and CB width are larger than or equal to 8 luma samples; bidirectional prediction with coding unit weights (“BCW”) weight index indicates equal weight (it should be understood that, in the context of a weighted averaging bi-prediction equation wherein a weighted averaging of two prediction signals is calculated, an “equal weight” is a weight parameter which causes the two prediction signals to be weighted equally in the equation); weighted bi-prediction (“WP”) is not enabled for the current block; and combined inter-intra prediction (“CIIP”) mode is not used for the current block.

A refined MV derived by DMVR is used to generate the inter prediction samples and also used in temporal motion vector prediction for future pictures coding. The original MV is used in deblocking and also used in spatial motion vector prediction for future CB coding.

Additional features of DMVR are mentioned subsequently.

In DVMR, a refined MV search starts from a search center and encompasses a search range of refined MVs immediately surrounding an initial MV, the span of the search range delineating a search window, the range of searched refined MVs being offset obeying the MV difference mirroring rule. In other words, any points that are searched by DMVR, denoted by a candidate MV pair (MV₀, MV₁) obey the following Equation 1 and Equation 2, respectively:

MV₀′=MV₀+MV_{offset}

MV₁′=MV₁−MV_{offset}

where MV_{offset} represents the MV refinement offset between the initial MV and the refined MV in one of the reference pictures. A refined MV search range (also referred to as a “search step” below) is two integer-distance luma samples from the initial MV. A refined MV search includes two stages: an integer sample offset search and a fractional sample refinement.

For the purpose of understanding example embodiments of the present disclosure, all subsequent references to one or more “points” being searched should be understood as referring to individual luma samples of a block or subblock, separated by integer distances.

A 25-point full search is applied for an integer sample offset search. The SAD of the initial MV pair is first calculated. If the SAD of the initial MV pair is smaller than a threshold, the integer sample stage of DMVR terminates. Otherwise the remaining 24 search points are searched in raster scanning order, calculating the SAD of each search point. The search point with the smallest SAD is selected as an integer-distance refined MV, which is output by the integer sample offset search. To reduce the penalty of the uncertainty of DMVR refinement, the original MV can be favored during the DMVR process. The SAD between the reference blocks referred by the initial MV candidates is decreased by ¼ of the SAD value.

An integer sample offset search can be followed by fractional sample refinement. To reduce computational complexity, a fractional sample refinement is performed by solving a parametric error surface equation, instead of further searching by SAD comparison. The fractional sample refinement is conditionally invoked based on the output of the integer sample offset search. When the integer sample offset search terminates with center having the smallest SAD in either a first iteration or a second iteration search, the fractional sample refinement is further applied. Otherwise, the integer-distance refined MV can be output as a refined MV.

In parametric error surface-based sub-pixel offsets estimation, the center position cost and the costs at four neighboring positions from the center are used to fit a 2-D parabolic error surface as described by Equation 3 below:

E(x,y)=A(x−xₘᵢₙ)²+B(y−yₘᵢₙ)²+C

where (xₘᵢₙ, yₘᵢₙ) corresponds to the fractional position with the least cost and C corresponds to the minimum cost value. By solving the above equations using the cost value of the five search points, the (xₘᵢₙ, yₘᵢₙ) is computed respectively according to Equation 4 and Equation 5 below:

xₘᵢₙ=(E(−1,0)−E(1,0))/(2(E(−1,0)+E(1,0)−2E(0,0)))

yₘᵢₙ=(E(0,−1)−E(0,1))/(2((E(0,−1)+E(0,1)−2E(0,0)))

The value of xₘᵢₙ and yₘᵢₙ are constrained by default to be between −8 and 8 since all cost values are positive and the smallest value is E(0,0). This corresponds to half-pel offset with 1/16th-pel MV accuracy in VVC. The computed fractional (xₘᵢₙ, yₘᵢₙ) are added to the integer-distance refined MV to obtain a subpixel-accurate refined delta MV. The subpixel-accurate refined delta MV can be output as a refined MV instead of the integer-distance refined MV.

In VVC, resolution of the MVs is 1/16 luma samples. The samples at the fractional position are interpolated using an 8-tap interpolation filter. In DMVR, since refined MV search points are the points immediately surrounding the initial fractional-pel MV with integer sample offset, the samples of those fractional positions need to be interpolated for a DMVR refined MV search. To reduce the calculation complexity, a bi-linear interpolation filter is used to generate the fractional samples for a DMVR refined MV search. Moreover, by using a bi-linear filter with 2-sample search range, the DVMR does not access more reference samples compared to a standard motion compensation process. After a refined MV is output by a DMVR refined MV search, the standard 8-tap interpolation filter is applied to generate the final prediction. In order to not access more reference samples than the standard motion compensation process, the samples, which are not needed for the interpolation process based on the original MV but are needed for the interpolation process based on the refined MV, will be padded from those available samples.

When the width and/or height of a CB are larger than 16 luma samples, it will be further split into subblocks with width and/or height equal to 16 luma samples. The maximum unit size for the DMVR refined MV search is limited to 16×16.

In ECM, to further improve the coding efficiency, a multi-pass decoder-side motion vector refinement is applied. In the first pass, BM is applied to the coding block. In the second pass, BM is applied to each 16×16 subblock within the coding block. In the third pass, the MV in each 8×8 subblock is refined by applying bi-directional optical flow (“BDOF”). The refined MVs are stored for both spatial and temporal motion vector prediction.

In the first pass, a refined MV is derived by applying BM to a coding block. Similar to DMVR, in bi-prediction, a refined MV is searched near the two initial MVs (MV0 and MV1) in the reference picture lists L0 and L1. The refined MVs (MV0_pass1 and MV1_pass1) are derived near the initial MVs based on the minimum bilateral matching cost between the two reference blocks in L0 and L1.

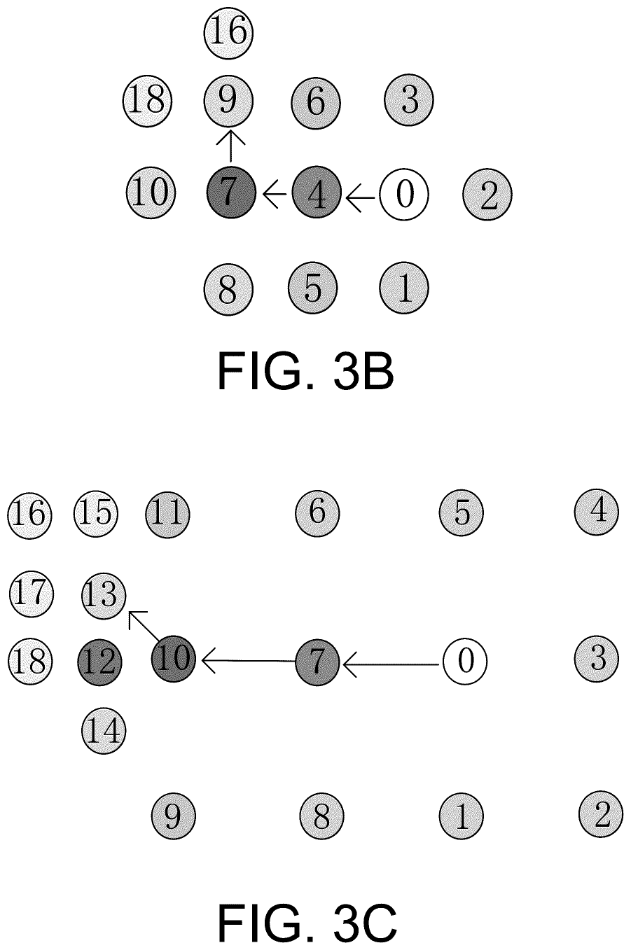

BM-based refinement performs a local search to derive integer sample precision intDeltaMV. The local search applies a 3×3 square search pattern to loop through the search range [—sHor, sHor] in a horizontal direction and [—sVer, sVer] in a vertical direction, wherein, the values of sHor and sVer are determined by the block dimension, and the maximum value of sHor and sVer is 8 or other values. For example, in FIG. 3A, point 0 is the position to which the initial MV refers and set as a first search center. Thus, the points 1 to 8 surrounding the initial point are searched first and the cost of each position is calculated.

In a first search iteration, point 7 is found having minimum cost, point 7 is set as a second search center, and points 9, 10 and 11 are searched. In a next search iteration, cost of point 10 is found smaller than cost of point 7, 9, 11, so a third search center is set to point 10, and points 12, 13 and 14 are searched. In a next search iteration, point 12 is found having minimum cost among points 6 to 14, so point 12 is set as a fourth search center. In a next search iteration, costs of points 10, 11, 13, and 15 to 19 surrounding the point 12 are all found larger than cost of point 12, then point 12 is an optimal point and the refined MV search terminates, outputting a refined MV corresponding to the optimal point. Thus, FIG. 3A illustrates an example diagram of a search pattern (e.g., a 3×3 square search pattern) used in a first pass of a multi-pass decoder-side motion vector refinement.

The bilateral matching cost can be calculated as: bilCost=mvDistanceCost+sadCost, wherein sadCost is the SAD between L0 predictor (i.e., a reference block from reference picture L0) and L1 predictor (i.e., a reference block from reference picture L1) on a search point and mvDistanceCost is based on intDeltaMV (i.e., the distance between the search point and the initial point). When the block size cbW (CB width, in pixels)*cbH (CB height, in pixels) is greater than 64, the mean-removed SAD (“MRSAD”) cost function is applied to remove the discrete cosine (“DC”) effect of distortion between reference blocks. When the bilCost at the center point of the 3×3 search pattern has the minimum cost, the intDeltaMV local search terminates. Otherwise, the current minimum cost search point is set as the new center point of the 3×3 search pattern and the search for the minimum cost continues, until the end of the search range is reached.

The existing fractional sample refinement is further applied to derive fractional MV refinement fracDeltaMV, and the final deltaMV is derived as intDeltaMV+fracDeltaMV. The refined MVs after the first pass are then respectively derived according to Equation 6 and Equation 7 below:

MV0_pass1=MV₀+deltaMV

MV1_pass1=MV₁−deltaMV

In the second pass, a refined MV is derived by applying BM to a 16×16 grid subblock. For each subblock, a refined MV is searched near the two MVs (MV0_pass1 and MV1_pass1), obtained on the first pass, in the reference picture list L0 and L1. The refined MVs (MV0_pass2(sbIdx2) and MV1_pass2(sbIdx2)) are derived based on the minimum bilateral matching cost between the two reference subblocks in L0 and L1.

For each subblock, BM-based refinement performs a full search to derive integer sample precision intDeltaMV(sbIdx2). The full search has a search range [−sHor, sHor] in a horizontal direction and [−sVer, sVer] in a vertical direction, wherein the values of sHor and sVer are determined by the block dimension, and the maximum value of sHor and sVer is 8 or other values.

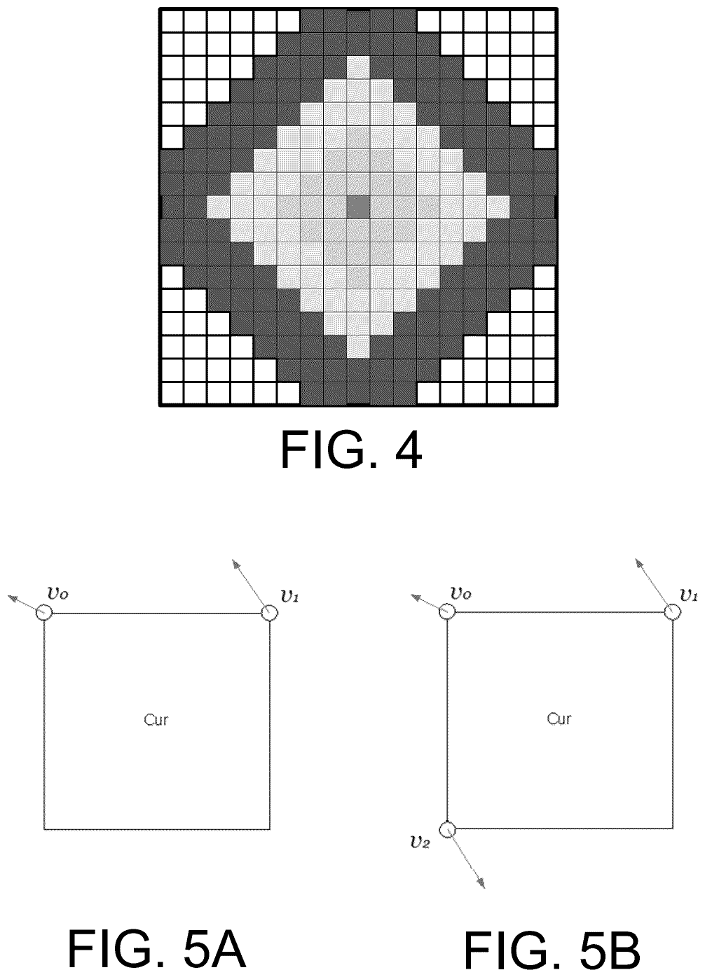

The bilateral matching cost can be calculated by applying a cost factor to the sum of absolute transformed differences (“SATD”) cost between two reference subblocks, as: bilCost=satdCost*costFactor. The search area (2*sHor+1)*(2*sVer+1) is divided up to 5 diamond-shaped search regions, as shown in FIG. 4. FIG. 4 illustrates a diagram of bilateral matching costs (each matching cost corresponding to a differently-shaded diamond-shaped search region) used in a second pass of a multi-pass decoder-side motion vector refinement. Each search region is assigned a costFactor, which is determined by the distance intDeltaMV(sbIdx2) between each search point and the starting MV, and each diamond-shaped region is processed in order starting from the center of the search area. In each region, the search points are processed in the raster scan order starting from the top left going to the bottom right corner of the region. When the minimum bilCost within the current search region is less than a threshold equal to sbW (subblock width)*sbH (subblock height), the int-pel full search terminates; otherwise, the int-pel full search continues to the next search region until all search points are examined. Additionally, if the difference between the previous minimum cost and the current minimum cost in the iteration is less than a threshold that is equal to the area of the block, the search terminates.

Furthermore, the bilateral matching costs as described above can also be calculated based on MRSAD instead of SAD, and can also be calculated based on mean-removed sum of absolute transformed differences (“MRSATD”) instead of SATD.

The existing VVC DMVR fractional sample refinement is further applied to derive the final deltaMV(sbIdx2). The refined MVs at second pass are then respectively derived according to Equation 8 and Equation 9 below:

MV0_pass2(sbIdx2)=MV0_pass1+deltaMV(sbIdx2)

MV1_pass2(sbIdx2)=MV1_pass1−deltaMV(sbIdx2)

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv(Vx, Vy) is rounded to 1/16 sample precision and clipped between −32 and 32,

The refined MVs (MV0 pass3(sbIdx3) and MV1_pass3(sbIdx3)) at third pass are respectively derived according to Equation 10 and Equation 11 below:

MV0_pass3(sbIdx3)=MV0_pass2(sbIdx2)+bioMv

MV1_pass3(sbIdx3)=MV0_pass2(sbIdx2)−bioMv

In ECM, adaptive decoder-side motion vector refinement is an extension of multi-pass DMVR which includes the two new merge modes to refine MV only in one temporal direction, either reference picture L0 or reference picture L1, of the bi prediction for the merge candidates that meet the DMVR conditions. The multi-pass DMVR process is applied for the selected merge candidate to refine the motion vectors, however either MVD0 or MVD1 is set to zero in the first pass (i.e., PU level) DMVR. Thus, a new merge candidate list is constructed for adaptive decoder-side motion vector refinement. The new merge mode for the new merge candidate list is called BM merge in ECM.

The merge candidates for BM merge mode are derived from spatial neighboring coded blocks, temporal based motion vector predictors (“TMVPs”), non-adjacent blocks, history-based motion vector predictors (“HMVPs”), pair-wise candidates, similar to the regular merge mode. The difference is that only those merge candidates meeting DMVR conditions are added to the merge candidate list. The same merge candidate list is used by the two new merge modes. If the list of BM candidates contains the inherited BCW weights and the DMVR process is unchanged except the computation of the distortion is made using MRSAD or MRSATD if the weights are non-equal and the bi-prediction is weighted with BCW weights. Merge index is coded as in regular merge mode.

In HEVC, only a translation motion model is applied for motion compensation prediction (“MCP”). In the real world, however, many kinds of motion occur, such as zoom in/out, rotation, perspective motions and the other irregular motions. In VVC, a block-based affine transform motion compensation prediction is applied. As shown in FIGS. 5A and 5B, the affine motion field of the block is described by motion information of two control point motion vectors (4-parameter) (FIG. 5A) or three control point motion vectors (6-parameter) (FIG. 5B).

In affine motion compensation, for a 4-parameter affine motion model, the motion vector at sample location (x, y) in a block is derived according to Equation 12 below:

$$\{ \begin{matrix}{mv}_{x} = \frac{{mv}_{1 x} - {mv}_{0 x}}{W} x + \frac{{mv}_{0 y} - {mv}_{1 y}}{W} y + {mv}_{0 x} \\ {my}_{y} = \frac{{mv}_{1 y} - {mv}_{0 y}}{W} x + \frac{{mv}_{1 x} - {mv}_{0 x}}{W} y + {mv}_{0 y}\end{matrix}$$

For a 6-parameter affine motion model, the motion vector at a sample location (x, y) in a block is derived according to Equation 13 below:

$$\{ \begin{matrix}{mv}_{x} = \frac{{mv}_{1 x} - {mv}_{0 x}}{W} x + \frac{{mv}_{2 x} - {mv}_{0 x}}{W} y + {mv}_{0 x} \\ {my}_{y} = \frac{{mv}_{1 y} - {mv}_{0 y}}{W} x + \frac{{mv}_{2 y} - {mv}_{0 y}}{W} y + {mv}_{0 y}\end{matrix}$$

where (mv₀ₓ, mv_{0y}) is a motion vector of the top-left corner control point, (mv₁ₓ, mv_{1y}) is a motion vector of the top-right corner control point, and (mv₂ₓ, mv_{2y}) is a motion vector of the bottom-left corner control point.

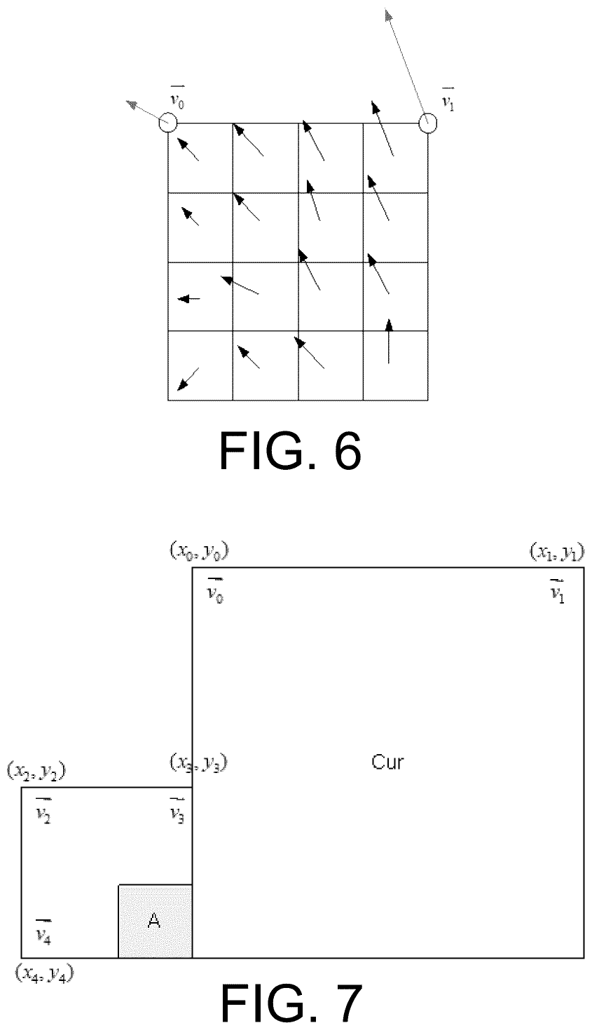

In order to simplify the motion compensation prediction, block-based affine transform prediction is applied. To derive a motion vector of each 4×4 luma subblock, the motion vector of the center sample of each subblock, as shown in FIG. 6, is calculated according to the above equations, and rounded to 1/16 fraction accuracy. FIG. 6 illustrates a diagram of affine motion vectors of luma subblocks calculated for each subblock center sample. According to ECM, the subblock size is adaptively decided. If the motion vector difference of two neighboring luma subblock is smaller than a threshold, neighboring luma subblocks will be merged into larger subblocks. If the motion vector difference of the two neighboring larger subblock is still smaller than the threshold, the larger subblock will continue to be merged until the motion vector difference of the two neighboring subblocks is larger than the threshold or until the subblock is equal to the whole block.

After motion vector of a subblock is derived, the motion compensation interpolation filters are applied to generate a predictor of each subblock with the derived motion vector. The subblock size of chroma-components is dependent on the size of luma subblock. The MV of a chroma subblock is calculated as an average of the MVs of the top-left and bottom-right luma subblocks in the collocated luma region.

As done for translational motion inter prediction, there are two affine motion inter prediction modes: affine merge mode and affine advanced motion vector prediction (“AMVP”) mode.

Affine merge mode (AF_MERGE) can be applied for CBs with both width and height larger than or equal to 8. In this mode the control point motion vectors (“CPMVs”) of the current CB are generated based on the motion information of the spatial neighboring CBs. There can be up to 15 affine candidates, and an index is signaled to indicate the one to be used for the current CB. The following eight types of candidates are used to form the affine merge candidate list: inherited candidates from adjacent neighbors; inherited candidates from non-adjacent neighbors; constructed candidates from adjacent neighbors; the second type of constructed affine candidates from non-adjacent neighbors; the first type of constructed affine candidates from non-adjacent neighbors; a regression based affine merge candidate; pairwise affine; and zero MVs.

The inherited affine candidates are derived from an affine motion model of the adjacent or non-adjacent blocks. When an adjacent or non-adjacent affine CB is identified, its control point motion vectors are used to derive the control point motion vector prediction (“CPMVP”) candidate in the affine merge candidate list of the current CB. As shown in FIG. 7 (illustrating a diagram of control point motion vector inheritance, candidates from which are used to form an affine merge candidate list), if the neighbor left bottom block A is coded in affine mode, the motion vectors v₂, v₃ and v₄ of the top-left corner, the above-right corner and the bottom-left corner of the CB which contains the block A are obtained. For a block A coded with a 4-parameter affine model, the two CPMVs of the current CB are calculated according to v₂, and v₃. For a block A coded with a 6-parameter affine model, the three CPMVs of the current CB are calculated according to v₂, v₃ and v₄.

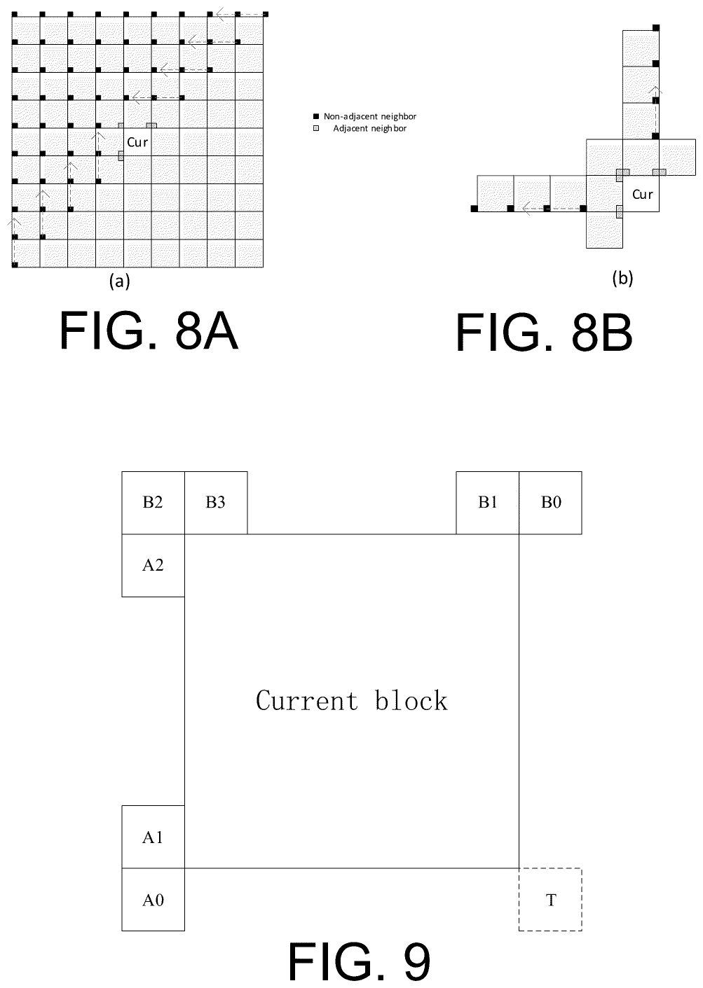

For inherited candidates from non-adjacent neighbors, the non-adjacent spatial neighbors are checked based on their distances to the current block, i.e., from near to far. At a specific distance, only the first available neighbor (that is coded with the affine mode) from each side (e.g., the left side and above side) of the current block is included for inherited candidate derivation. As indicated by the broken-lined arrows in FIG. 8A, the checking orders of the neighbors on the left and above sides are bottom-to-up and right-to-left, respectively. FIGS. 8A and 8B illustrate diagrams of, respectively, inherited candidates from non-adjacent neighbors for the affine merge candidate list and constructed candidates of a first type for the affine merge candidate list.

Constructed affine candidates from adjacent neighbors are the candidates constructed by combining the neighbor translational motion information of each control point. The motion information for the control points is derived from the specified spatial neighbors and temporal neighbors, as shown in FIG. 9 (FIG. 9 illustrates a diagram of locations of constructed affine candidates from adjacent neighbors for the affine merge candidate list). CPMVₖ (k=1, 2, 3, 4) represents the k-th control point. For CPMV₁, the B2->B3->A2 blocks are checked and the MV of the first available block is used. For CPMV₂, the B1->B0 blocks are checked and for CPMV₃, the A1->A0 blocks are checked. TMVP is used as CPMV4 if it's available.

After MVs of four control points are obtained, affine merge candidates are constructed based on that motion information. The following combinations of control point MVs are used to construct in order:
{CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, {CPMV₁, CPMV₃}
   The combination of 3 CPMVs constructs a 6-parameter affine merge candidate and the combination of 2 CPMVs constructs a 4-parameter affine merge candidate. To avoid a motion scaling process, if the reference indices of control points are different, the related combination of control point MVs is discarded.

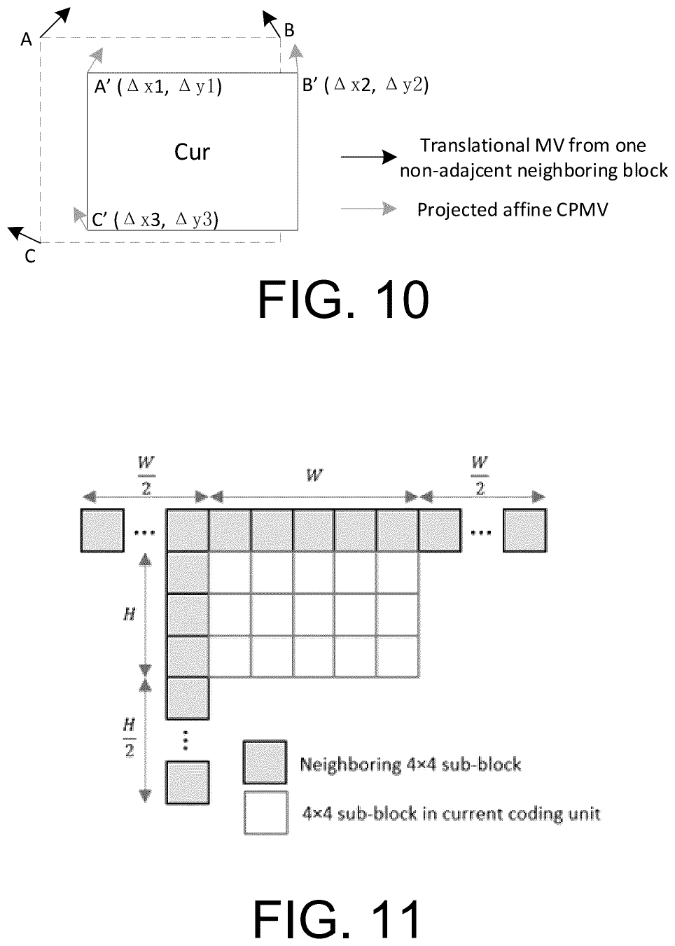

For the first type of constructed candidates from non-adjacent neighbors, as shown in FIG. 8B, the positions of one left and above non-adjacent spatial neighbors are firstly determined independently; after that, the location of the top-left neighbor can be determined accordingly, which can enclose a rectangular virtual block together with the left and above non-adjacent neighbors. Then, as shown in FIG. 10, the motion information of the three non-adjacent neighbors is used to form the CPMVs at the top-left (A), top-right (B) and bottom-left (C) of the virtual block, which are finally projected to the current CB to generate the corresponding constructed candidates. FIG. 10 illustrates a diagram of locations of constructed affine candidates from non-adjacent neighbors for the affine merge candidate list.

For the second type of constructed candidates, the affine model parameters are inherited from the non-adjacent spatial neighbors. Specifically, the second type of affine constructed candidates are generated from the combination of 1) the MVs of adjacent neighboring 4×4 blocks; and 2) the affine model parameters inherited from the non-adjacent spatial neighbors as defined in FIG. 8A.

For the regression based affine merge candidates, subblock motion field from a previously coded affine CB and motion information from adjacent subblocks of a current CB are used as the inputs to the regression process to derive the affine candidates. The previously coded affine CB can be identified from scanning through non-adjacent positions and the affine HMVP table. Adjacent subblock information of current CB is fetched from 4×4 sub-blocks represented by the grey zone as depicted in FIG. 11. For each sub-block, given a reference list, the corresponding motion vector and center coordinate of the sub-block may be used. For each affine CB, up to 2 regression based affine candidates can be derived. One with adjacent subblock information and one without. All the linear-regression-generated candidates are pruned and collected into one candidate sub-group and TM cost based ARMC process is applied when ARMC is enabled. Afterwards, up to N linear-regression-generated candidates are added to the affine merge candidate list when N affine CBs are found.

After inserting all the above merge candidates into the merge candidate list, if the list is still not full, zero MVs are inserted to the end of the list.

Subblock-based affine motion compensation can save memory access bandwidth and reduce computation complexity compared to pixel-based motion compensation, at the cost of a prediction accuracy penalty. To achieve a finer granularity of motion compensation, prediction refinement with optical flow (“PROF”) is used to refine the subblock-based affine motion compensated prediction without increasing the memory access bandwidth for motion compensation. In VVC, after the subblock-based affine motion compensation is performed, the luma prediction sample is refined by adding a difference derived by the optical flow equation. The PROF is described as following four steps:

First, the subblock-based affine motion compensation is performed to generate subblock prediction i(i, j).

Second, the spatial gradients gₓ(i,j) and g_{y}(i,j) of the subblock prediction are respectively calculated at each sample location using a 3-tap filter [−1, 0, 1] according to Equation 14 and Equation 15 below. The gradient calculation is the same as gradient calculation in BDOF.

gₓ(i,j)=(I(i+1,j)>>shift1)−(I(i−1,j)>>shift1)

g_{y}(i,j)=+1)>>shift1)−−1)>>shift1)

shift1 is used to control the gradient's precision. The subblock (i.e., 4×4) prediction is extended by one sample on each side for the gradient calculation. To avoid additional memory bandwidth and additional interpolation computation, those extended samples on the extended borders are copied from the nearest integer pixel position in the reference picture.

Third, the luma prediction refinement is calculated according to the following optical flow Equation 16.

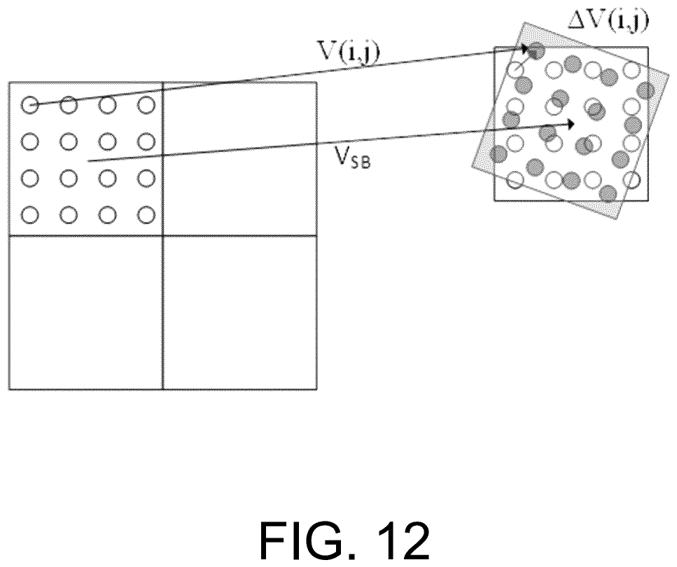

ΔI(i,j)=gₓ(i,j)*Δvₓ(i,j)+g_{y}(i,j)*Δv_{y}(i,j)

where the Δv(i,j) is the difference between sample MV computed for sample location (i,j), denoted by v(i,j), and the subblock MV of the subblock to which sample (i,j) belongs, as shown in FIG. 12. The Δv(i,j) is quantized in the unit of 1/32 luma sample precision. FIG. 12 illustrates a diagram of a difference Δv(i,j) between a subblock motion vector v_{SB} at a location and a motion vector v(i,j) calculated at that location, the difference used as part of a predication refinement with optical flow for a subblock-based affine motion compensated prediction.

Since the affine model parameters and the sample location relative to the subblock center are not changed from subblock to subblock, Δv(i,j) can be calculated for the first subblock, and reused for other subblocks in the same CB. Let dx(i, j) and dy(i, j) be the horizontal and vertical offset from the sample location (i,j) to the center of the subblock (x_{SB}, y_{SB}), derived according to Equation 17 below. Δv(x, y) can then be derived according to Equation 18 below.

$$\{ \begin{matrix}dx ( i , j ) = i - {x}_{SB} \\ dy ( i , j ) = j - {y}_{SB}\end{matrix} \\ \{ \begin{matrix}Δ {v}_{x} ( i , j ) = C * dx ( i , j ) + D ( dy ( i , j ) \\ Δ {v}_{Y} ( i , j ) = E * dx ( i , j ) + F * dy ( i , j )\end{matrix}$$

In order to keep accuracy, the center of the subblock (x_{SB}, y_{SB}) is calculated as ((WSB−1)/2, (HSB−1)/2), where WSB and HSB are the subblock width and height, respectively.

For a 4-parameter affine model, the parameters C, D, E, and F are derived according to Equation 19 below:

$$\{ \begin{matrix}C = F = \frac{{v}_{1 x} - {v}_{0 x}}{w} \\ E = - D = \frac{{v}_{1 y} - {v}_{0 y}}{w}\end{matrix}$$

For a 6-parameter affine model, the parameters C, D, E, and F are derived according to Equation 20 below:

$$\{ \begin{matrix}C = \frac{{v}_{1 x} - {v}_{0 x}}{w} \\ D = \frac{{v}_{2 x} - {v}_{0 x}}{h} \\ E = \frac{{v}_{1 y} - {v}_{0 y}}{w} \\ F = \frac{{v}_{2 y} - {v}_{0 y}}{h}\end{matrix}$$

where (v₀ₓ, v_{0y}), (v₁ₓ, v_{1y}), (v₂ₓ, v_{2y}) are the top-left, top-right and bottom-left control point motion vectors, w and h are the width and height of the CB.

Fourth, the luma prediction refinement ΔI(i, j) is added to the subblock prediction I(i, j). The final prediction I′ is generated according to Equation 21 below:

I′(i,j)=1(0)+ΔI(i,j)

PROF is not applied in two cases for an affine coded CB: 1) all control point MVs are the same, which indicates the CB only has translational motion; 2) the affine model parameters are greater than a specified limit because the subblock-based affine motion compensation is degraded to CB-based motion compensation to avoid large memory access bandwidth requirement.

According to the VVC standard and ECM proposals as described above, DMVR is only applied to non-affine coded blocks to refine motion vector of translation motion, and, for blocks coded with affine mode, DMVR is not used to refine the motion vectors. However, motion vectors of affine merge mode-coded blocks, similar to motion vectors of translation motion compensation-coded blocks, are also inherited from the previously coded blocks and thus may not perfectly match with the current block. Therefore, in this disclosure, a VVC-standard encoder and decoder configure one or more processors of a computing system to apply DMVR on affine merge mode-coded blocks to refine the motion vector accuracy and thereby improve coding efficiency.

It should be understood that “decoder-side” does not mean that this method is implemented exclusively by decoders; rather, steps of this method can be implemented similarly or identically by encoders and decoders, as shall be described subsequently.

As described herein, in an affine model used to code a block in affine merge mode, a motion vector at sample location (x, y) can be derived according to Equation 22 below:

$$\{ \begin{matrix}{mv}_{x} = ax + by + {mv}_{0 x} \\ {mv}_{y} = cx + dy + {mv}_{0 y}\end{matrix}$$

wherein (mvₓ, mv_{y}) is the derived motion vector at sample location (x, y); (mv₀ₓ,mv_{0y}) denotes a MV of the affine model, which is the motion vector at sample location (0, 0); and a, b, c, and dare the parameters of the affine model. Affine motion may include, but is not limited to, translation, rotation and zooming. The MV of the affine model represents the translation motion of the affine model. Affine model parameters a, b, c, and d represent non-translation motion of the affine model, including rotation and zooming and other non-translation motion. The affine model parameters can be derived based on the motion vectors at two sample locations for a 4-parameter affine model and three non-colinear sample locations for a 6-parameter affine model. As a generalization of the above Equation 22, the MV of an affine model can be the motion vector at any sample location, not necessarily at location (0, 0). Taking a motion vector at sample location (w, h) as the MV of the affine model (denoted as (mv_{wx}, mv_{wy})), a motion vector at sample location (x, y) can be formulated according to Equation 23 below:

$$\{ \begin{matrix}{mv}_{x} = a ( x - w ) + b ( y - h ) + {mv}_{wx} \\ {mv}_{y} = c ( x - w ) + d ( y - h ) + {mv}_{wy}\end{matrix}$$

For a 4-parameter affine model, b is equal to c and d is equal to a. Thus, a 4-parameter affine model can be formulated according to Equation 24 below:

$$\{ \begin{matrix}{mv}_{x} = a ( x - w ) - c ( y - h ) + {mv}_{wx} \\ {mv}_{y} = c ( x - w ) + a ( y - h ) + {mv}_{wy}\end{matrix}$$

Theoretically, all the parameters of affine model, including a, b, c, d, mv_{wx}, and mv_{wy} can be refined at once in DMVR. However, to limit computational complexity of refinement, according to an example embodiment of the present disclosure, affine model parameters a, b, c, and dare fixed while an affine model MV (mv_{wx}, mv_{wy}) is refined, and the affine model MV is fixed while the affine model parameters a, b, c, and d are refined. Subsequently, a refined MV search wherein affine model parameters are fixed is described, and an affine parameter offset search wherein an affine model MV is fixed is also described.

Similar to a standard DMVR implementation, a VVC-standard encoder and decoder configure one or more processors of a computing system to apply DMVR refined MV search for an initial MV, as described above except where indicated below. In contrast to a standard DMVR implementation, during a refined MV search, when calculating the bilateral matching cost (whether based on SAD or SATD, or MRSAD or MRSATD) between two predictors of reference picture L0 and reference picture L1 (i.e., a reference block from reference picture L0 and a reference block from reference picture L1), the motion compensation is performed at subblock-level. Thus, a refined MV search is performed for an initial MV for some number of iterations of an integer sample offset search, which can be followed by a fractional sample refinement, the refined MV search outputting a refined MV. An affine model is used to derive the MV of each subblock of a current affine-coded block, and motion compensation is performed at subblock-level to obtain a predictor of the current affine-coded block. A SAD or SATD (or MRSAD or MRSATD) of two predictors (one being from a L0 reference picture and the other being from a L1 reference picture) of the current affine coded block are calculated to derive a bilateral matching cost of each current search point. An integer sample offset search terminates after some number of search iterations, yielding an optimal point, which can be output as a refined MV, or can have fractional sample refinement further applied thereto before outputting a refined MV.

In one example, a CPMV is refined. Starting from an initial set of CPMVs referring to an initial point, an MV refinement offset is added to each CPMV to obtain a surrounding search point according to Equation 25, Equation 26, Equation 27, Equation 28, Equation 29, and Equation 30 below:

CPMV0_l0′=CPMV0_l0+MV_offset

CPMV0_l1′=CPMV0_l1−MV_offset

CPMV1_l0=CPMV1_l0+MV_offset

CPMV1_l1′=CPMV1_l1−MV_offset

CPMV2_l0′=CPMV2_l0+MV_offset

CPMV2_l1′=CPMV2_l1−MV_offset

wherein CPMVx_l0 is the x-th CPMV referring to reference picture L0 and CPMVx_l1 is the x-th CPMV referring to reference picture L1. MV_offset is a MV refinement offset for a search point, i.e., the difference between the initial CPMV and the refined CPMV. An affine model is applied to calculate the MV of each subblock, then subblock-level motion compensation is applied to obtain a predictor of the current block. During the refined MV search, affine model parameters as described above are fixed. It should be understood that while the refined MV search includes multiple search iterations, these iterations collectively make up one search, and the refined MV search itself need not be performed multiple times (as the MV refinement offsets are non-variable).

During each iteration in a refined MV search, multiple search points are searched about a search center, where each search point is an individual luma sample as described above; to search multiple search points, standard search schemes can be applied. For example, as shown in FIG. 3A, a 3×3 square search about a search center may be performed in an integer sample offset search; then, the fractional search as well as the fractional error surface estimation method can be applied to derive an optimal MV_offset. By way of another example, a cross search about a search center is used to reduce the points searched. As illustrated in FIG. 3B, point 0, the position to which the initial MV refers is set as a first search center. Thus, the points 1 to 4 surrounding the search center are searched first and the cost of each search point is calculated.

In a first search iteration, point 4 is found having minimum cost, point 4 is set as a second search center, and points 5, 6 and 7 are searched. In a next search iteration, cost of point 7 is found to be smaller than cost of point 4, 5 and 6, so a third search center is set to point 7, and points 8 to 10 are searched. In a next search iteration, point 9 is found having minimum cost among points 7 to 10, so point 9 is set as a fourth search center. In a next search iteration, costs of points 6, 16 and 18 surrounding the point 9 are all found larger than cost of point 9, then point 9 is an optimal point.

By way of yet another example, a 3×3 square search and a 3×3 cross search can be performed in conjunction. A square search is performed in the first k iterations, followed by a cross search performed to determine the optimal point; or, a cross search is performed first and then a square search is performed to determine the optimal point.

In another embodiment, a VVC-standard encoder and decoder configure one or more processors of a computing system to apply an adaptive search step to speed up a refined MV search. In the first one or more k earlier search iterations, a search step is set to an initial step (e.g., 2) and in one or more later search iterations following the earlier search iterations, the search step is changed to a smaller step (e.g., 1). As illustrated in FIG. 3C, point 0 is the position to which the initial MV refers and set as a first search center. The points 1 to 8 surrounding the initial point are searched first and a search step is set to 2, so the distance between point 1, 2, 3, 4, 5, 6, 7, 8 and point 0 is 2 pixels (Manhattan Distance is used here, not Euclidian distance).

Next, in a second search iteration, the cost at point 7 is a minimum cost, the search center is point 7, and the search step is still set to 2. Search points 9, 10 and 11 are all 2 pixels away from search center point 7, and point 10 is found having minimum cost.

Next, in a third search iteration, the search center is point 10, and the search step is changed to 1. Search points 12 to 14 are each 1 pixel away from point 10. Suppose that point 13 is found having minimum cost.

Next, in a fourth search iteration, the search center is 13, the search step is 1, and the points 11, 15, 16, 17, and 18 are each 1 pixel away from search center point 13. The adaptive search step can also be applied in cross search pattern or another search pattern.

For each search point, the subblock MV is recalculated with the CPMV of the current search point, and the predictor of the block is derived by performing subblock-based affine motion compensation with the subblock MV derived.

The cost of each search point can be calculated as cost=mvDistanceCost+sadCost, wherein sadCost is the SAD between L0 predictor and L1 predictor of the current block and mvDistanceCost is based on the distance between the search point and the initial point (i.e., the difference between the refined CPMV and the initial CPMV).

To control the complexity of refinement, PROF may be or may not be applied before SAD calculation during the refined MV search. If PROF is applied, for each search point, after obtaining the predictor, the PROF is applied to refine the predictor and the SAD is calculated between two PROF refined predictors. If PROF is not applied, for each search point, SAD is directly calculated after L0 predictor and L1 predictor are obtained.

Also, to further reduce complexity of refined MV search, for each search point, the predictor may be generated with 2-tap bilinear interpolation filter instead of 8-tap or 12-tap interpolation filter.

In another example, a VVC-standard encoder and decoder configure one or more processors of a computing system to perform subblock MV refinement. Subblock MV is derived with the initial CPMVs, and then an MV refinement offset is added to each subblock MV to refine the subblock MV according to Equation 31 and Equation 32 below:

MV(sbx)_l0′=MV(sbx)_l0+MV_offset

MV(sbx)_l1′=MV(sbx)_l1−MV_offset

wherein MV(sbx)_l0 and MV(sbx)_l1 are the MV of subblock X referring to reference picture L0 and reference picture L1, respectively. MV_offset with the current search point is added to all the subblock MVs to obtain the refined subblock MVs. Motion compensation is then performed at subblock-level with each subblock MV to obtain the two predictors of the whole CB. The SAD or the SATD (or MRSAD or MRSATD) is calculated between the two predictors and a bilateral matching cost of the current search is obtained. The search point with the minimum cost is treated as the optimal point and the corresponding MV_offset is obtained as the optimal MV refinement offset. The refined subblock MV can be calculated according to Equation 31 and Equation 32. PROF may be or may not be applied before SAD calculation during refined MV search. An interpolation filter with a reduced number of taps can be used instead of 8-tap or 12-tap interpolation filter to generate the predictors during refined MV search. The search method and the cost calculation method applied in CPMV refinement can also be applied in subblock MV refinement.

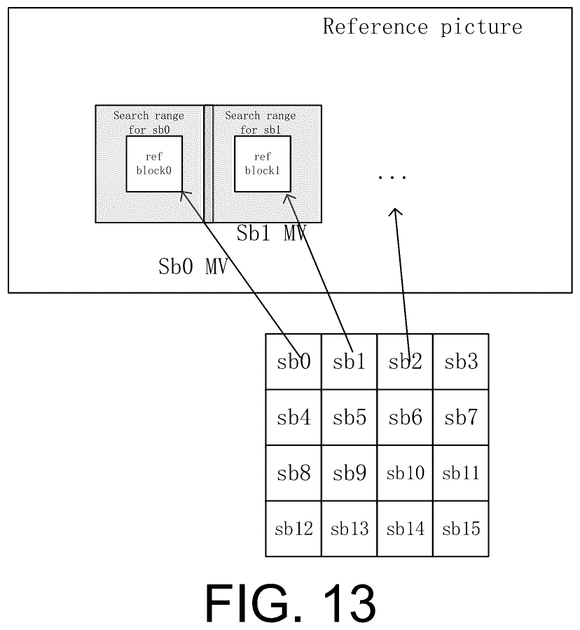

To reduce search complexity, pre-interpolated samples of the predictor on all search points within the search window can stored at a buffer before the refined MV search. Then, for each search point, the predictor of each sub-block can be directly fetched from the buffer without interpolation. As shown in FIG. 13, a coding block is divided into sixteen s4×4 subblocks for affine motion compensation. The initial CPMVs are used to calculate initial subblock MV for each subblock. For each subblock, a reference subblock (i.e., predictor of the subblock) can be located in the reference picture by the initial subblock MV. Because the refinement is applied on subblock MV, for each search point, all of the reference subblocks are shifted by the same MV refinement offset. Thus, for each subblock, the samples of the reference subblocks on all the search points within each search window can be pre-interpolated as the shaded region in FIG. 13. Then for a search point, the sample of the reference block on that search point can be directly fetched from the search window without interpolation, thereby sparing computing time and resources spent on further interpolations.

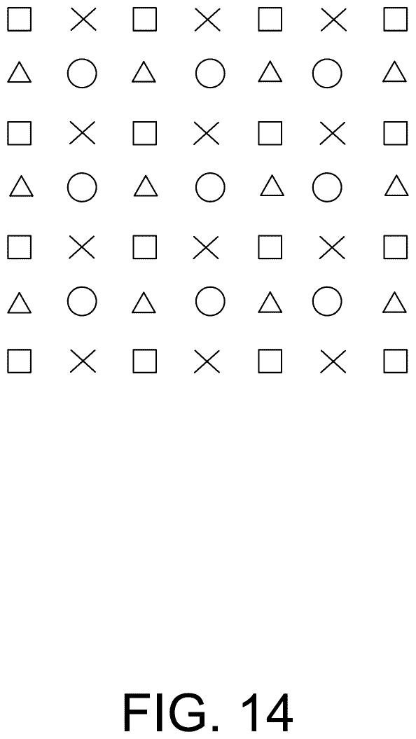

A VVC-standard encoder and decoder can configure one or more processors of a computing system to apply pre-interpolation (i.e., to interpolate all the samples in the search window before refined MV search so that for each search point the predicted samples can be directly fetched and no interpolation need to be invoked) in an integer sample offset search and a fractional sample refinement. For an integer sample offset search, the samples pre-interpolated are all one pixel away from each other. In fractional sample refinement, dependent on the phase, the pre-interpolated samples may be stored separately. As shown in FIG. 14, squares denote the samples for the integer search points which can be all pre-interpolated; X signs denote the samples at ½ pel position in horizontal direction but at integer position in vertical direction; triangles denote the samples at ½ pel position in vertical direction but at integer position in horizontal direction; and circles denote the samples at ½ pel position both in horizontal and vertical direction. In view of ½ pel search process, there can be three different phases of samples and the distance between two neighboring fractional samples with the same phase is also one pixel. Thus, the fractional samples with the same type can be pre-interpolated together and different phases of samples may be stored separately.

After CB-level MV refinement, sub-CB level MV refinement can also be applied. For example, a CB is divided into multiple sub-CBs which is larger than the subblock (e.g., 16×16 sub-CB) in affine motion compensation. For each sub-CB, the affine model MV is further refined: the subblocks in one sub-CBs share the same MV refinement offset. The final MV of each respective subblock can be formulated according to Equation 33 and Equation 34 below:

MV(sbx)_l0′=MV(sbx)_l0+MV_offset+MV_offset(sbCUx)

MV(sbx)_l1′=MV(sbx)ₗ₁−MV_offset−MV_offset(sbCUs)

wherein MV(sbx)_l0 and MV(sbx)_l1 are the L0 and L1 MV of subblock X, respectively. MV_offset is the MV refinement offset obtained in the CB-level MV refinement process and MV_offset(sbCUx) is the MV refinement offset obtained in the sub-CB level MV refinement for a sub-CB X in which subblock X is located. MV(sbx)_l0′ and MV(sbx)_l1′ are the final refined MVs for subblock X. The motion compensation is performed with the refined subblock MV at subblock-level.

Search range can be set dependent on PU size or QPs, to reduce computational complexity at the cost of reduced performance, or to improve performance at the cost of increased computational complexity. By way of example, because larger CBs may benefit from greater refinement, a larger search range may be set for a larger CB, and a smaller search range may be set for a smaller CB. By way of another example, larger QPs may benefit from larger search ranges, due to greater distortion. Therefore, a larger search range may be set for a larger QP, and a smaller search range may be set for a smaller QP. Alternatively, to achieve encoding time reduction, setting a small search range for a larger QP can significantly reduce points searched. Therefore, in some examples, a smaller search range may be set for a larger QP, and a larger search range may be set for a smaller QP.

To further reduce computational complexity, a PU size restriction can be imposed. A PU size restriction parameter specifies that the process of affine DMVR is skipped for some sizes of CBs. For example, affine DMVR is not applied for the CB smaller than 8×8 or 16×16, or affine DMVR is not applied for the CB larger than 64×64 or 128×128.

In some examples, to reduce computational complexity, a VVC-standard encoder and decoder configure one or more processors of a computing system to apply early termination to the DMVR refined MV search for the affine block. By way of example, if a search point is checked in the search of a previous candidate in the affine merge candidate list, the search point is skipped. By way of another example, if the SAD on a search point is smaller than a predefined threshold, the refined MV search terminates and the search point is used as the optimal position after refinement.

In some examples, to reduce complexity for encoder and decoder, a VVC-standard encoder and decoder configure one or more processors of a computing system to apply a fast algorithm. By way of example, if the difference of the current affine merge candidate (i.e., the current initial MV) and the previous checked affine merge candidate (i.e. the previous initial MV) is smaller than a threshold, the entire process of DMVR for the current affine merge candidate is skipped. The current affine merge candidate is directly used for motion compensation of the current block without refinement. The threshold can be dependent on the current block size, such that larger blocks have larger threshold than smaller blocks. By way of another example, DMVR is disabled for the affine coded block with size smaller/larger than a threshold. DMVR is not applied to blocks smaller than a threshold, or is not applied to blocks larger than a threshold, to refine the motion. The threshold can be fixed or signaled in the bitstream.

As mentioned above, the parameters of affine model, including a, b, c, d and mv_{wx}, mv_{wy} can be refined in DMVR; thus, aside from the MV of the affine model, parameters of the affine model can also be refined.

In some examples, a VVC-standard encoder and decoder configure one or more processors of a computing system to perform 4-parameter refinement upon an affine model. Based on the affine model denoted in Equation 23, offset_a, offset_b, offset_c and offset_d are added to the parameters a, b, c and d to refine these parameters. Both encoder and decoder search offset_a, offset_b, offset_c and offset_d to minimize a bilateral matching cost (as described above, whether calculated based on SAD or SATD or MRSAD or MRSATD) between a L0 predictor (i.e., a reference block from reference picture L0) and a L1 predictor (i.e., a reference block from reference picture L1) of the affine coded block (subsequently referred to as an “affine parameter offset search,” where a parameter offset which minimizes the bilateral matching cost is subsequently referred to as an “optimal parameter offset”). Refinement of the respective parameters proceeds according to Equation 35, Equation 36, Equation 37, Equation 38, Equation 39, Equation 40, Equation 41, and Equation 42 below:

a_l0′=a_l0+offset_a

a_l1′=a_l1−offset_a

b_l0′=b_l0+offset_b

b_l1′=b_l1−offset_b

c_l0′=c_l0+offset_c

c_l1′=c_l1−offset_c

d_l0′=d_l0+offset_d

d_l1′=d_l1−offset_d

wherein a_l0, b_l0, c_l0 and d_l0 are the parameters of the affine model for reference list 0 and a_l1, b_l1, c_l1 and d_l1 are the parameters of the affine model for reference list 1. Each of the four parameters are refined.

After affine parameter refinement, the subblock MV of list 0 and list 1 may be derived according to the affine model of Equations 22 to 24 with a_l0′, b_l0′, c_l0′, d_l0′ and a_l1′, b_l1′, c_l1′, d_l1′, and then subblock MVs may be derived and motion compensation may be performed at subblock-level.

Furthermore, the bilateral matching cost (whether based on SAD or SATD or MRSAD or MRSATD) can be calculated either at subblock-level or CB-level. If the bilateral matching cost is calculated at subblock-level, after motion compensation of each subblock, the cost of that subblock is calculated; after obtaining the costs of the subblocks, the CB-level cost is calculated by summing up all subblock cost.

If the bilateral matching is cost is calculated at CB-level, motion compensation of each subblock is performed first to obtain the L1 and L0 predictor of the whole CB, and then cost of the whole is calculated. To reduce the calculation complexity, in some embodiments, not all subblocks or not all samples of the CB are considered in the bilateral matching cost calculation. Only the differences of some subblocks or some samples are calculated, so the motion compensation of the subblocks or the samples which are not considered in the cost calculation can also be skipped.

Alternatively, a VVC-standard encoder and decoder configure one or more processors of a computing system to perform 2-parameter refinement upon an affine model. For a 4-parameter affine model, since b is equal to −c and d is equal to a, the refinement may also obey this constraint: offset_b is equal to −offset_c, and offset_d is equal to offset_a. Thus, the encoder and the decoder only need to perform affine parameter offset search for offset_a and offset_b and derive offset_b and offset_d according to offset_a and offset_b.

As affine parameter offset searching for 2 parameter offsets is less computationally complex than affine parameter offset searching for 4 parameter offsets, the constraint that offset_b is equal to −offset_c and offset_d is equal to offset_a can also be applied in DMVR applied to a 6-parameter affine model. The refinement of the respective parameters proceeds according to Equation 43, Equation 44, Equation 45, Equation 46, Equation 47, Equation 48, Equation 49, and Equation 50 below:

a_l0′=a_l0+offset_a

a_l1′=a_l1−offset_a

b_l0′=b_l0−offset_c

b_l1′=b_l1+offset_c

c_l0′=c_l0+offset_c

c_l1′=c_l1−offset_c

d_l0′=d_l0+offset_a

d_l1′=d_l1−offset_a

Furthermore, 4-parameter refinement can also be applied to a 4-parameter model or a 6-parameter model. For both 4-parameter and 6-parameter affine models, the same refinement as Equation 35, Equation 36, Equation 37, Equation 38, Equation 39, Equation 40, Equation 41, and Equation 42 above are applied.

In some examples, a VVC-standard encoder and decoder configure one or more processors of a computing system to apply a refined MV search scheme in an affine parameter offset search. For example, as shown in FIG. 3A or 3B, a 3×3 square search or a 3×3 cross search may be applied to yield the optimal parameter offset. For 4-parameter refinement, the square search or the cross search is conducted in 4-dimension space. The 3×3×3×3 square search or the 3×3×3×3 cross search may be applied to obtain the optimal parameter offset. For a 3×3×3×3 square search, for each central position, there are 80 neighboring positions to be searched; for a 3×3×3×3 cross search, for each central position, there are 8 neighboring positions to be searched, which is much less than a 3×3×3×3 square search.

Suppose the parameter offset of the current central position is (offset_a, offset_b, offset_c, offset_d), the eight neighboring positions to be searched in a 3×3×3×3 cross search are (offset_a+step_a, offset_b, offset_c, offset_d), (offset_a—step_a, offset_b, offset_c, offset_d), (offset_a, offset_b+step_b, offset_c, offset_d), (offset_a, offset_b, −step_b offset_c, offset_d), (offset_a, offset_b, offset_c+step_c, offset_d), (offset_a, offset_b, offset_c−step_c, offset_d), (offset_a, offset_b, offset_c, offset_d+step_d), (offset_a, offset_b, offset_c, offset_d−step_d), where step_a, step_b, step_c and step_d are search steps for parameters a, b, c and d, respectively.

After an optimal parameter offset is returned from the affine parameter offset search, error surface-based offsets estimation can also be applied to further refine the returned parameter with higher precision. A search step of an integer search can be a fixed value. According to some examples, as the MV precision is 1/16 in ECM, and the basic subblock for affine motion compensation is 4×4, the search step can be 1/64 so that MV difference of two adjacent subblocks is 1/64 *4= 1/16, which is the minimum difference for a MV. In some other examples, the search step can be larger than 1/64. A larger search step reduces search iterations to reduce search time, but may sacrifice refinement precision. In another example, the search step is dependent on the CB size. Denoting the width of a CB as w and the height of a CB as h, the search step for a and c as step_{ac} and the search step for d and b as step_{bd}, the search step may satisfy Equation 51 below:

w×step_{ac}=T1

h×step_{bd}=T2

wherein T1 and T2 are two thresholds, which can be 1/16, ⅛, ¼ or other values. This threshold defines the maximum MV difference between MVs of any two samples within the block. According to this example, different parameters have different search steps.

For the cost of each search point, the difference of the parameter offsets can also be considered. The cost can be a weighted sum of the SAD or SATD (or MRSAD or MRSATD) between two predictors of the coding block and the parameter offset as bilCost=w*ParameterOffsetCost+sadCost, wherein w is a weight, sadCost is the SAD/SATD or mean removed SAD/SATD cost of the predictors and ParameterOffsetCost is a cost dependent on the parameter offset of the refined parameters. When w is equal to 0, only sadCost is considered.

Furthermore, according to an example embodiment of the present disclosure, during an affine parameter offset search, an MV of the affine model can be fixed.

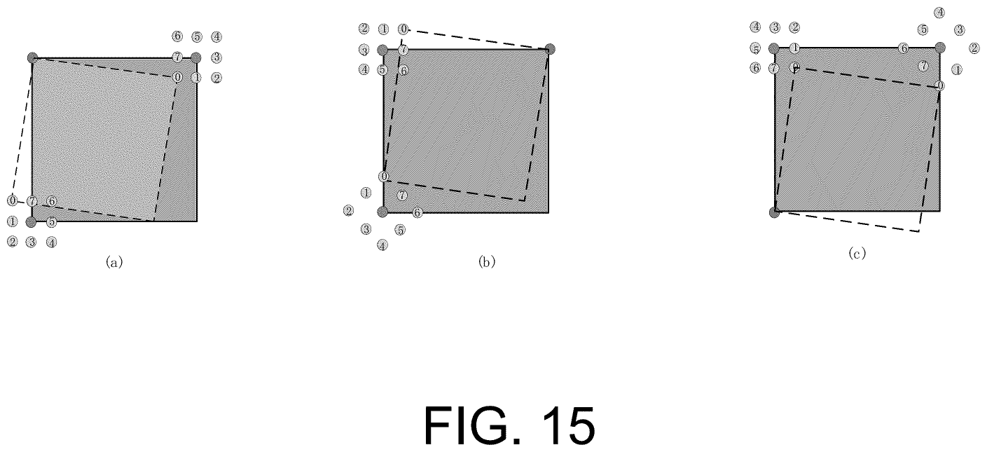

During any affine parameter offset search, one MV of the affine model is fixed. Unlike a refined MV search, multiple affine parameter offset searches can be performed, and a different MV of the affine model can be fixed during different affine parameter offset searches. Any MV at any point in the plane can be treated as the affine model MV and therefore fixed in the parameter search. In one implementation, a CPMV is treated as the affine model MV which is fixed during the search. For example, the top-left CPMV is fixed, and the affine model parameters are refined shown as FIG. 15(a). With the change of the parameters, the coding block rotates and zooms in/out, so the top-right CPMV and the right-bottom CPMV are also changed. Then, the subblock MV is derived from the refined CPMVs (i.e., derived from the refined parameters and the new CPMV), and motion compensation is performed. FIG. 15(b) and FIG. 15(c) illustrate examples of where the top-right CPMV and the bottom-left CPMV, respectively, are treated as the affine model MV which is fixed while 4 affine model parameters are refined. Similar to FIG. 15(a), with the refinement of affine model parameters, the coding block rotates and zooms in/out, so the non-fixed CPMVs are changed. Multiple affine parameter offset searches can be performed because the non-fixed CPMVs can yield different optimal parameter offsets (as well as different MV refinement offsets).

In another implementation, various CPMVs, each being treated as affine model MV, are fixed in turn for several affine parameter offset searches performed in turn. In a first affine parameter offset search, the top-left CPMV is fixed and the parameter offsets are searched as shown in FIG. 15(a). With the refined parameters, the top-right CPMV is also changed and can be calculated accordingly. Then in a second affine parameter offset search, as shown in FIG. 15(b), the refined top-right CPMV is fixed and the parameters are refined again. With the refined parameters obtained in the second sub-step, the left-bottom CPMV is also changed and can be calculated accordingly. Then in a third affine parameter offset search, the refined left-bottom CPMV is fixed and the parameters are refined again, as shown in FIG. 15(c). The same affine parameter offset searches can be repeated several times: the third affine parameter offset search can be followed by the first affine parameter offset search with new top-left CPMV fixed, and the searches can continue until certain conditions are satisfied. For example, the conditions may include but are not limited to: 1) a pre-set iteration number; 2) the SAD or SATD (or MRSAD or MRSATD) between L0 predictor and L1 predictor less than a threshold; 3) the current fixed CPMV is the same or similar as that in last iteration; 4) the optimal parameter offsets yielded by a latest affine parameter offset search is less than a threshold.

In yet another embodiment, instead of CPMVs, a zero MV found in the plane is treated as the affine model MV which is fixed during the refinement. First, the point at (x, y) with zero MV is derived according to Equation 52 below.

$$\{ \begin{matrix}{mv}_{x} = ax + by + {mv}_{0 x} = 0 \\ {mv}_{y} = cx + dy + {mv}_{0 y} = 0\end{matrix}$$

Assume that the solution is (x₁, y₁), so the affine model can be represented according to Equation 53 below with the zero MV:

$$\{ \begin{matrix}\begin{matrix}{mv}_{x} = ax + by + {mv}_{0 x} = a ( x - {x}_{1} ) + b ( y - {y}_{1} ) + \\ {ax}_{1} + {by}_{1} + {mv}_{0 x} = a ( x - {x}_{1} ) + b ( y - {y}_{1} )\end{matrix} \\ \begin{matrix}{mv}_{y} = cx + dy + {mv}_{0 y} = c ( x - {x}_{1} ) + d ( y - {y}_{1} ) + \\ {cx}_{1} + {dy}_{1} + {mv}_{0 y} = c ( x - {x}_{1} ) + d ( y - {y}_{1} )\end{matrix}\end{matrix}$$

Then, the affine model parameters a, b, c and d are searched to find a refined value. All the above refining methods can be applied in this embodiment.

As described before, the affine parameter refinement process is similar to the MV refinement process. The search is conducted over iterations, the iterations collectively making up one affine parameter offset search. For each iteration, if the bilateral matching cost of the central position is less than all the neighboring position, the current central position is found as the optimal position and the search terminates; otherwise, the neighboring position with the least bilateral matching cost is set as a new center position and the search advances to the next iteration.

Therefore, to control search complexity, a VVC-standard encoder and decoder configure one or more processors of a computing system to perform a maximum number of search iterations in each affine parameter offset search, the number of search iterations being configured at both encoder-side and decoder-side. The search terminates when either the central position has the least cost, or the maximum search iteration threshold achieves the pre-set maximum iteration threshold. A larger maximum search iteration threshold can yield more coding performance gain but consume longer encoding and decoding time.

To achieve a good trade-off between computational complexity and performance, the maximum search iteration threshold may be set depending upon a fixed MV, QP, temporal layer, CB size, etc. For example, according to the search process as illustrated in FIGS. 15(a) to (c), in the first affine parameter offset search, the top-left CPMV is fixed, and the maximum search iteration threshold is set to a larger value relative to subsequent thresholds, such as 8; as it is the first time parameters are refined, the larger search iteration threshold can configure one or more processors of a computing system to make use of longer computational time to improve coding and decoding performance.

Next, in the second affine parameter offset search, the top-right CPMV is fixed, and the maximum search iteration threshold is set to a smaller value relative to a previous threshold, such as 6; as the parameters are already refined in the first affine parameter offset search, a small search iteration threshold can save coding and decoding time.

Next, in the third affine parameter offset search, the bottom-left CPMV is fixed, and the maximum search iteration threshold is set to a smaller value relative to a previous threshold, such as 2, to further save coding and decoding time. Thus, in this embodiment, the maximum search iteration threshold is set to a larger value in the beginning and changed to a smaller value in later affine parameter offset searches.

In some other embodiments, the maximum search iteration threshold of the later affine parameter offset searches are dependent on the actual number of search iterations performed during previous affine parameter offset searches. For example, in the first affine parameter offset search when the top-left CPMV is fixed, the maximum search iteration threshold is set to N. However, during the first affine parameter offset search, the search actually terminates in a k-th (k<N) search iteration, due to the central position having the minimum bilateral matching cost. Next, in the second affine parameter offset search, the maximum search iteration threshold is set to k/2 (or other values dependent on k and less than P).

In contrast, if, in the first affine parameter offset search, the maximum number of search iterations allowed by the threshold is performed, then, in the second affine parameter offset search, the maximum search iteration threshold is set to P which is a value less than N. A similar method can be applied in the third affine parameter offset search: if the actual search iteration number performed in the second affine parameter offset search is the maximum number, the maximum search iteration threshold of the third affine parameter offset search is set to is L where L is less than P; if the actual search iteration number is t which does not achieve the maximum number, the maximum search iteration threshold of the third affine parameter offset search is set to t/2. Thus, the maximum search iteration threshold is adaptively determined in a previous search iteration.

In some other embodiments, to reduce the complexity, the search neighboring positions of a search iteration is reduced adaptively according to the previous search iteration. For example, in the 3×3×3×3 cross search scheme, there are eight neighboring positions to be searched in each search iteration. Suppose the current center is (a, b, c, d) and the eight neighboring positions to be checked are pa0=(a+s, b, c, d), pa1=(a−s, b, c, d), pb0=(a, b+s, c, d), pb1=(a, b−s, c, d), pc0=(a, b, c+s, d), pc1=(a, b, c−s, d), pd0=(a, b, c, d+s) and pd1=(a, b, c, d−s), respectively. The bilateral matching cost of eight neighboring positions are denoted as cost_pa0, cost_pa1, cost_pb0, cost_pb1, cost_pc0, cost_pc1, cost_pd0, and cost_pd1.

A VVC-standard encoder and decoder configure one or more processors of a computing system to compare cost_pa0 and cost_pa1: if cost_pa0 is less than cost_pa1, then only positive offsets are considered for parameter a in the next iteration; if cost_pa0 is greater than cost_pa1, then only negative offsets are considered for parameter a in the next iteration.

A VVC-standard encoder and decoder configure one or more processors of a computing system to compare cost_pb0 and cost_pb1: if cost_pb0 is less than cost_pb1, then only positive offsets are considered for parameter b in the next iteration; if cost_pb0 is greater than cost_pb1, then only negative offsets are considered for parameter b in the next iteration.

A VVC-standard encoder and decoder configure one or more processors of a computing system to compare cost_pc0 and cost_pc1: if cost_pc0 is less than cost_pc1, then only positive offsets are considered for parameter c in the next iteration; if cost_pc0 is greater than cost_pc1, then only negative offsets are considered for parameter c in the next iteration.

A VVC-standard encoder and decoder configure one or more processors of a computing system to compare cost_pd0 and cost_pd1: if cost_pd0 is less than cost_pd1, then only positive offsets are considered for parameter din the next iteration; if cost_pd0 is greater than cost_pd1, then only negative offsets are considered for parameter din the next iteration.

Suppose for the current search iteration, cost_pa0 is less than cost_pa1, cost_pb0 is greater than cost_pb1, cost_pc0 is less than cost_pc1 and cost_pd0 is greater than cost_pd1, then in the next search iteration the four neighboring positions to be checked are (a′+s, b′, c′, d′), (a′, b′−s, c′, d′), (a′, b′, c′+s, d′) and (a′, b′, c′, d′−s) where (a′, b′, c′, d′) is the center position of the next search iteration.

In some other embodiments, the minimum bilateral matching cost of the current search iteration is compared with that of a previous search iteration, or compared with that of a previous search iteration multiplied by a factor f. If the minimum cost reduction is a small amount, the search terminates. For example, if the cost of a previous search iteration is A which means the cost of the current search center is A, the minimum cost of the neighboring positions is B at position posb, where B<A. According to this search rule, the search goes to the next iteration with search centerposb. However, in this embodiment, if A−B<K or B>A*f the search terminates and the posb is selected as the optimal position of this search iteration. K and f are pre-set thresholds. For example, f is a factor less than 1, like 0.95, 0.9 or 0.8.

QP controls the quantization in video coding. With a higher QP, a bigger quantization step is used, and thus more distortion is introduced. Thus, for a higher QP, more search iterations are needed in the refinement, increasing encoding time. To reduce total coding time, in this embodiment, a smaller maximum search iteration threshold is set for a higher QP than for a lower QP.

Other methods for reducing complexity may also be used in high QP. For example, reducing the neighboring positions to be searched; adaptively reducing the search iteration; or early terminating the search dependent on the previous search process may be implemented. Thus, in this embodiment, different search strategies may be adopted in different QPs.

An inter-coded frame, such as a B frame or a P frame, has one or more reference frames. The time distance between the current frame and reference frame impacts the accuracy of the inter prediction. The time distance between two frames in video coding is usually represented by POC distance. Usually, with a longer POC distance, the inter prediction accuracy is lower and the motion information accuracy is also lower, and thus it needs more refinement. Thus, in this embodiment, the search process depends on the POC distance between the current frame and the reference frame.

For a hierarchical B frame, the frame with a higher temporal layer has short POC distance to the reference frame and the frame with a lower temporal layer has longer POC distance to the reference frame. Thus, the search process can also depend on the temporal layer of the current frame. For example, affine parameter refinement can be disabled for a high temporal layer, as a high temporal layer has short POC distance to the reference frame and may not need refinement. In another example, a small search iteration threshold is set, or neighboring search positions are reduced, for a high temporal layer frame.

Also, other methods to reduce the complexity of parameter refinement can be used for the high temporal layer frame. Thus, in this embodiment, the parameter refinement process depends on the temporal or the POC distance between the current frame and the reference frame.

In all the above embodiments, the affine model parameters are directly refined. However, the affine motion may include translation, rotation and zooming. The translation is represented by the MV of the affine model, and rotation and zooming are represented by the affine model parameters. In another embodiment, the motion of rotation and zoom is refined explicitly. Based on the original affine model, an additional rotation and scaling is added. If the original affine model is described as Equation 22 above. Then a rotation with angle t and scaling with factor k is applied according to Equation 54 below:

$$\vert \begin{matrix}{mv}_{x} \\ {mv}_{y}\end{matrix} \vert = k \vert \begin{matrix}cos t & - sin t \\ sin t & cos t\end{matrix} \vert \vert \begin{matrix}ax + by + {mv}_{0 x} \\ cx + dy + {mv}_{0 y}\end{matrix} \vert$$

Wherein t and k are two parameters to be searched during the DMVR process. The current search methods can be applied to obtain the optimal values oft and k. Then the subblock MV is derived according to Equation 49 above, and subblock-based affine motion compensation is performed to obtain the predictor of the current affine-coded block.

All the existing early termination method in MV refinement can also be applied in parameter refinement. For example, during a refined MV search, if the SAD or SATD (or MRSAD or MRSATD) between two predictors are less than a threshold, the refined MV search terminates.

Similar with MV refinement, PROF may be or may not be applied before SAD calculation during the search process of affine model parameters. If PROF is applied, for each search point, after obtaining the predictor, the PROF is applied to refine the predictor and the SAD is calculated between two PROF refined predictors. If PROF is not applied, for each search point, SAD is directly calculated after L0 predictor and L1 predictor are obtained.

Also, to further reduce search complexity, for each search point, the predictor may be generated an interpolation filter with a reduced number of taps instead of 8-tap or 12-tap interpolation filter.

Affine parameter refinement and MV refinement can be performed in conjunction. In one embodiment, MV refinement and affine parameter refinement are performed successively. MV refinement can be followed by affine parameter refinement, or affine parameter refinement can be followed by MV refinement.

In an alternative embodiment, MV refinement and affine parameter refinement are refined in the same process. For affine models according to Equation 55 below:

$$\{ \begin{matrix}{mv}_{x} = ax + by + {mv}_{0 x} \\ {mv}_{y} = cx + dy + {mv}_{0 y}\end{matrix}$$

six parameters (a, b, c, d and mv0x, mv0y) are collectively refined. Optimal values of offset_a, offset_b, offset_c, offset_d, offset mv0x and offset mv0y are found in the search and the parameters are respectively refined according to Equation 56, Equation 57, Equation 58, Equation 59, Equation 60, Equation 61, Equation 62, Equation 63, Equation 64, Equation 65, Equation 66, and Equation 67 below:

a_l0=a_l0+offset_a

a_l1=a_l1−offset_a

b_l0=b_l0+offset_b

b_l1=b_l1−offset_b

c_l0=c_l0+offset_c

c_l1=c_l1−offset_c

d_l0=d_l0+offset_d

d_l1=d_l1−offset_d

mv₀ₓ_l0=mv₀ₓ_l0+offset_mv₀ₓ

mv₀ₓ_l1=mv₀ₓ_l1−offset_mv₀ₓ

mv_{0y}_l0=mv_{0y}_l0+offset_mv_{0y}

mv_{0y}_l0=mv_{0y}_l0−offset_mv_{0y}

wherein a_l0, b_l0, c_l0 and d_l0 are the initial parameters of the affine model for reference picture list 0, a_l1, b_l1, c_l1 and d_l1 are the initial parameters of the affine model for reference picture list 1, (mv₀ₓ_l0, mv_{0y}_l0) is an initial MV of the affine model for reference picture list 0 and (mv₀ₓ_l1, mv_{0y}_l1) is an initial MV of the affine model for reference picture list 1. a_l0′, b_l0′, c_l0′ and d_l0′ are the refined parameters of the affine model for reference list 0, a_l1, b_l1, c_l1 and d_l1 are the refined parameters of the affine model for reference list 1, (mv₀ₓ_l0′, mv_{0y}_l0′) is a refined MV of the affine model for reference picture list 0 and (mv₀ₓ_l1′, mv_{0y}_l1′) is a refined MV of the affine model for reference picture list 1. After refinement of these 6 parameters, the CPMVs are re-calculated and then the subblock MVs can be derived. Subblock-level motion compensation can be performed. This embodiment can also be combined with 4-parameter refinement restriction: offset_b is equal to −offset_c and offset_d is equal to offset_a.

Persons skilled in the art will appreciate that all of the above aspects of the present disclosure may be implemented concurrently in any combination thereof, and all aspects of the present disclosure may be implemented in combination as yet another embodiment of the present disclosure.

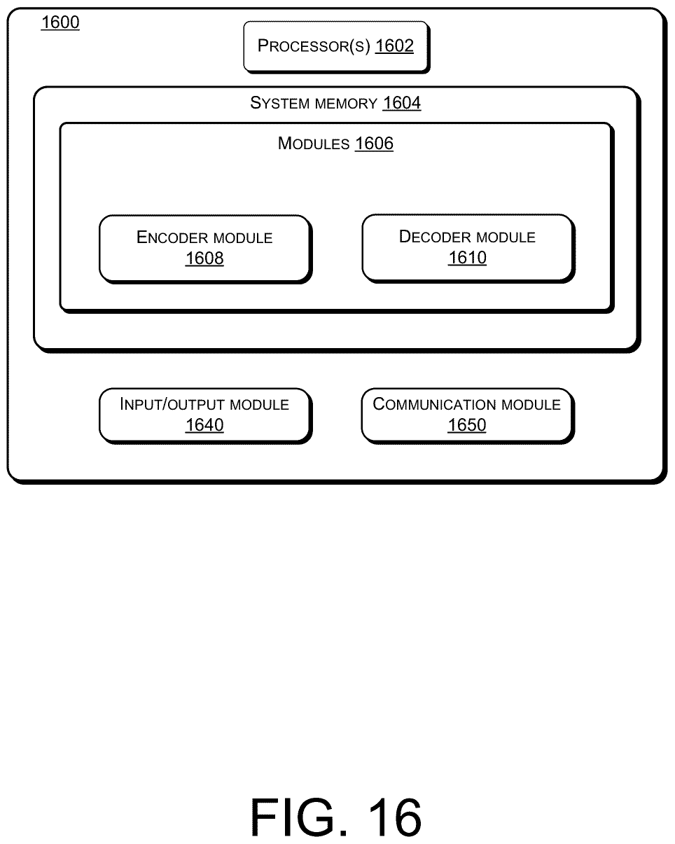

FIG. 16 illustrates an example system 1600 for implementing the processes and methods described herein for implementing a decoder-side motion vector refinement for affine motion compensation.

The techniques and mechanisms described herein may be implemented by multiple instances of the system 1600 as well as by any other computing device, system, and/or environment. The system 1600 shown in FIG. 16 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 1600 may include one or more processors 1602 and system memory 1604 communicatively coupled to the processor(s) 1602. The processor(s) 1602 may execute one or more modules and/or processes to cause the processor(s) 1602 to perform a variety of functions. In some embodiments, the processor(s) 1602 may include a central processing unit (“CPU”), a graphics processing unit (“GPU”), both CPU and GPU, or other processing units or components known in the art. Additionally, each of the processor(s) 1602 may possess its own local memory, which also may store program modules, program data, and/or one or more operating systems.

Depending on the exact configuration and type of the system 1600, the system memory 1604 may be volatile, such as RAM, non-volatile, such as ROM, flash memory, miniature hard drive, memory card, and the like, or some combination thereof. The system memory 1604 may include one or more computer-executable modules 1606 that are executable by the processor(s) 1602.

The modules 1606 may include, but are not limited to, an encoder module 1606 and a decoder module 1610. The encoder module 1608 and decoder module 1610 may be configured to perform any of the methods described above.

The system 1600 may additionally include an input/output (I/O) interface 1640 for receiving video source data and bitstream data, and for outputting decoded pictures into a reference picture buffer and/or a display buffer. The system 1600 may also include a communication module 1650 allowing the system 1600 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transitory computer-readable storage media that, when executed by one or more processors, may perform operations described above with reference to FIGS. 1A-15. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
performing a refined motion vector (MV) search for a control point motion vector (CPMV) of an inter-coded coding block (CB); and
outputting a refined MV of the CB.

2. The computing system of claim 1, wherein the operations further comprise:
outputting respective refined MVs of a plurality of CPMVs of the CB;
wherein each refined MV is derived from a same MV refinement offset applied to a respective initial CPMV.

3. The computing system of claim 1, wherein performing a refined MV search comprises:
deriving a MV of a subblock of the CB based on the CPMV of the CB;
performing subblock MV refinement for the MV of the subblock;
outputting a refined MV of the subblock; and
outputting the refined MV of the CB based on the refined MV of the subblock.

4. The computing system of claim 2, wherein performing a refined MV search further comprises performing a plurality of search iterations of an integer sample offset search at a plurality of search points about a search center to output an integer-distance refined MV.

5. The computing system of claim 3, wherein the operations further comprise:
obtaining predicted sample values of the CB based on the MV of the subblock by fetching a pre-interpolated sample of each search point about the search center without performing interpolation.

6. The computing system of claim 1, wherein performing a refined MV search comprises:
deriving an affine model parameter based on a plurality of CPMVs of the CB;
performing an affine parameter offset search for the affine model parameter;
outputting an optimal parameter offset; and
outputting the refined MV of the CB based on the optimal parameter offset.

7. The computing system of claim 6, wherein determining an affine model parameter based on a plurality of CPMVs comprises one of:
determining four affine model parameters based on three CPMVs;
determining two affine model parameters based on two CPMVs; or
determining four affine model parameters based on three CPMVs.

8. The computing system of claim 6, wherein affine parameter offset search is performed while fixing a CPMV of the CB; and
outputting the refined MV of the CB is further based on the fixed CPMV.

9. The computing system of claim 6, wherein performing the refined MV search comprises performing a plurality of refined MV searches in turn, each refined MV search comprising:
performing an affine parameter offset search for the affine model parameter while fixing a respectively different CMPV of the CB.

10. The computing system of claim 1, wherein the operation further comprise:
outputting respective refined MVs of a plurality of CPMVs of the CB;
wherein each refined MV is derived from a different MV refinement offset applied to a respective initial CPMV.

11. The computing system of claim 1, wherein each refined MV search further comprises performing a plurality of search iterations at a plurality of search points about a search center up to a maximum search iteration threshold, wherein respective maximum search iteration thresholds are smaller for each subsequent refined MV search.

12. The computing system of claim 1, wherein performing a refined MV search further comprises:
performing a plurality of search iterations of an integer sample offset search at a plurality of search points about a search center to output an integer-distance refined MV; and
applying fractional sample refinement to the integer-distance refined MV to output a subpixel-accurate refined delta MV.

13. The computing system of claim 1, wherein each refined MV search further comprises performing a plurality of search iterations at a plurality of search points about a search center.

14. The computing system of claim 13, wherein performing an iteration of the plurality of search iterations comprises one of: searching a plurality of search points by a square search about the search center, and searching a plurality of search points by a cross search about the search center.

15. The computing system of claim 13, wherein performing an iteration of the plurality of search iterations comprises:
calculating a bilateral matching cost of each search point of the plurality of search points based on two derived predictors of the CB from a reference picture in a first reference picture list and a reference picture in a second reference picture list, respectively;
determining a minimum bilateral matching cost among bilateral matching costs of each search point of the plurality of search points; and
terminating the refined MV search based on determining that the minimum bilateral matching cost is larger than a minimum bilateral matching cost of a previous iteration of the plurality of search iterations multiplied by a factor.

16. The computing system of claim 13, wherein performing an iteration of the plurality of search iterations comprises:
calculating a bilateral matching cost of each search point of the plurality of search points based on two derived predictors of the CB from a reference picture in a first reference picture list and a reference picture in a second reference list, respectively;
determining a minimum bilateral matching cost among bilateral matching costs of each search point of the plurality of search points; and
terminating the refined MV search based on a difference between the minimum bilateral matching cost and a minimum bilateral matching cost of a previous iteration of the plurality of search iterations.

17. The computing system of claim 13, wherein an iteration of the plurality of search iterations comprises:
calculating a bilateral matching cost of each search point of the plurality of search points based on two derived predictors of the CB from a reference picture in a first reference picture list and a reference picture in a second reference list, respectively; and
determining a minimum bilateral matching cost among each calculated.

18. The computing system of claim 17, wherein calculating the bilateral matching cost of each search point of the plurality of search points is based on a distance between the respective search point and the search center.

19. The computing system of claim 17, wherein the bilateral matching cost is calculated based on a sum of absolute differences, a sum of absolute transformed differences, a mean-removed sum of absolute differences, or a mean-removed sum of absolute transformed differences between the two derived predictors.

20. The computing system of claim 17, wherein an iteration of the plurality of search iterations further comprises not applying prediction refinement with optical flow (PROF) to the two derived predictors before calculating the bilateral matching cost.
